(19) United States
(12) Patent Application Publication
(10) Pub. No.: US 2024/0244512 A1
(43) Pub. Date: Jul. 18, 2024

(54) RESOURCE DETERMINING METHOD, DEVICE, AND READABLE STORAGE MEDIUM

(71) Applicant: VIVO MOBILE COMMUNICATION CO., LTD., Guangdong (CN)

(72) Inventors: Siqi LIU, Guangdong (CN); Zichao JI, Guangdong (CN)

(73) Assignee: VIVO MOBILE COMMUNICATION CO., LTD., Guangdong (CN)

(21) Appl. No.: 18/620,868

(22) Filed: Mar. 28, 2024

Related U.S. Application Data
(63) Continuation of application No. PCT/CN2022/121682, filed on Sep. 27, 2022.

(30) Foreign Application Priority Data
Sep. 29, 2021 (CN) 202111155069.8

(51) Int. Cl. H04W 48/16; H04W 24/10

(52) U.S. Cl. CPC H04W 48/16; H04W 24/10

(57) ABSTRACT

A resource determining method, a device, and a readable storage medium. The method includes: determining, by a terminal, a target sensing occasion for a first procedure; and determining, by the terminal, a target resource based on the target sensing occasion; where the target sensing occasion includes a first sensing occasion, or the target sensing occasion includes a first sensing occasion and a second sensing occasion, where the first sensing occasion is a sensing occasion corresponding to the first procedure, the second sensing occasion does not overlap with at least part of the first sensing occasion, at least part of the second sensing occasion corresponds to a second procedure, and the second procedure is a procedure different from the first procedure.

### CROSS-REFERENCE TO RELATED APPLICATIONS

This application is a continuation of International Application No. PCT/CN2022/121682 filed on Sep. 27, 2022, which claims priority to Chinese Patent application Ser. No. 20/211,1155069.8 filed on Sep. 29, 2021, which are incorporated herein by reference in their entireties.

### TECHNICAL FIELD

This application pertains to the field of communication technologies, and in particular, to a resource determining method, a device, and a readable storage medium.

### BACKGROUND

For a procedure (for example, a process, resource selection triggered by packet, re-evaluation, and/or pre-emption evaluation), if user equipment (UE) relies only on continuous partial sensing (CPS) and/or periodic based partial sensing (PBPS) corresponding to the procedure, the collision probability of determined available resources is still high due to insufficiency of sensing results.

### SUMMARY

According to a first aspect, a resource determining method is provided, and the method includes:

determining, by a terminal, a target sensing occasion for a first procedure; and

determining, by the terminal, a target resource based on the target sensing occasion;

where

the target sensing occasion includes a first sensing occasion, or the target sensing occasion includes a first sensing occasion and a second sensing occasion, where the first sensing occasion is a sensing occasion corresponding to the first procedure, the second sensing occasion does not overlap with at least part of the first sensing occasion, at least part of the second sensing occasion corresponds to a second procedure, and the second procedure is a procedure different from the first procedure.

According to a second aspect, a resource determining apparatus is provided, and the apparatus includes:

a first determining module, used by a terminal to determine a target sensing occasion for a first procedure; and

a second determining module, used by the terminal to determine a target resource based on the target sensing occasion; where

the target sensing occasion includes a first sensing occasion, or the target sensing occasion includes a first sensing occasion and a second sensing occasion, where the first sensing occasion is a sensing occasion corresponding to the first procedure, the second sensing occasion does not overlap with at least part of the first sensing occasion, at least part of the second sensing occasion corresponds to a second procedure, and the second procedure is a procedure different from the first procedure.

According to a third aspect, a terminal is provided. The terminal includes a processor, a memory, and a program that is stored in the memory and that can be run on the processor, and when the program is executed by the processor, the steps of the method according to the first aspect are implemented.

According to a fourth aspect, a readable storage medium is provided. The readable storage medium stores a program or an instruction, and the program or the instruction is executed by a processor to implement the steps of the method according to the first aspect.

According to a fifth aspect, a computer program product is provided. The computer program product is stored in a storage medium, and the computer program product is executed by at least one processor to implement the steps of the method according to the first aspect.

According to a sixth aspect, a chip is provided. The chip includes a processor and a communication interface, the communication interface is coupled to the processor, and the processor is configured to run a program or an instruction to implement the steps of the method according to the first aspect.

According to a seventh aspect, a communication device is provided, configured to perform the steps of the method according to the first aspect.

### BRIEF DESCRIPTION OF DRAWINGS

FIG. 1a is a schematic diagram of an architecture of a wireless communication system;

FIG. 1b is a schematic diagram of a principle of LTE sidelink sensing;

FIG. 1c is a schematic diagram of a principle of LTE partial sensing;

FIG. 1d is a schematic diagram of scenarios of PBPS and CPS in NR;

FIG. 1e is a schematic diagram of a scenario of SL resource pre-emption;

FIG. 1f is a schematic diagram of scenarios of a triggered slot and an existing slot;

FIG. 2 is a schematic flowchart of a resource determining method according to an embodiment of this application;

FIG. 3a to FIG. 3c are schematic diagrams of application scenarios according to an embodiment of this application;

FIG. 4 is a schematic diagram of an application scenario of non-monitor slots according to an embodiment of this application;

FIG. 5 is a schematic diagram of a structure of a resource determining apparatus according to an embodiment of this application; and

FIG. 6 is a schematic diagram of a structure of a terminal according to an embodiment of this application.

### DETAILED DESCRIPTION

The following clearly describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

The terms “first”, “second”, and the like in the specification and claims of this application are used to distinguish between similar objects instead of describing a designated order or sequence. It should be understood that, the terms used in such a way is interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communication systems such as Code Division Multiple Access

(CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. A new radio (NR) system is described below for an illustration purpose, and the term NR is used in most of the descriptions, although these technologies can also be used in an application other than an NR system application, for example, a 6^{th} generation (6G) communication system.

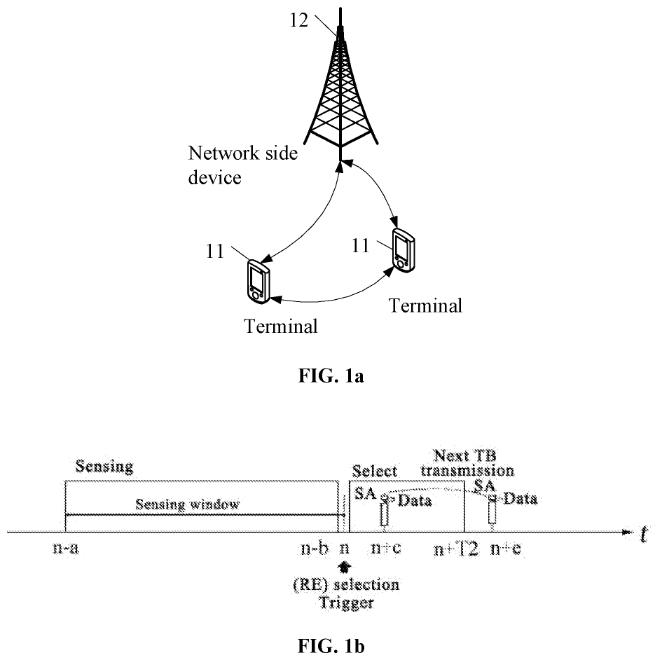

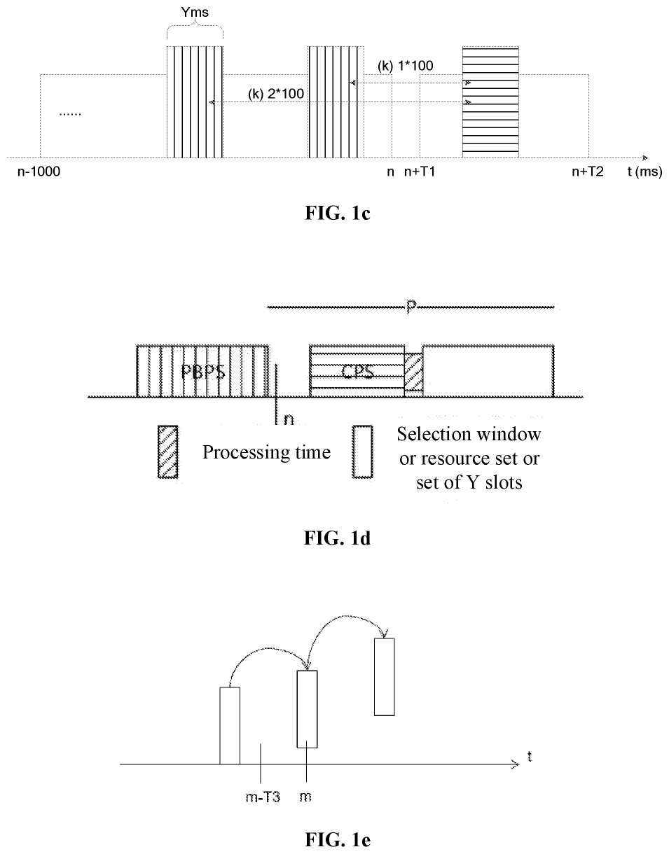

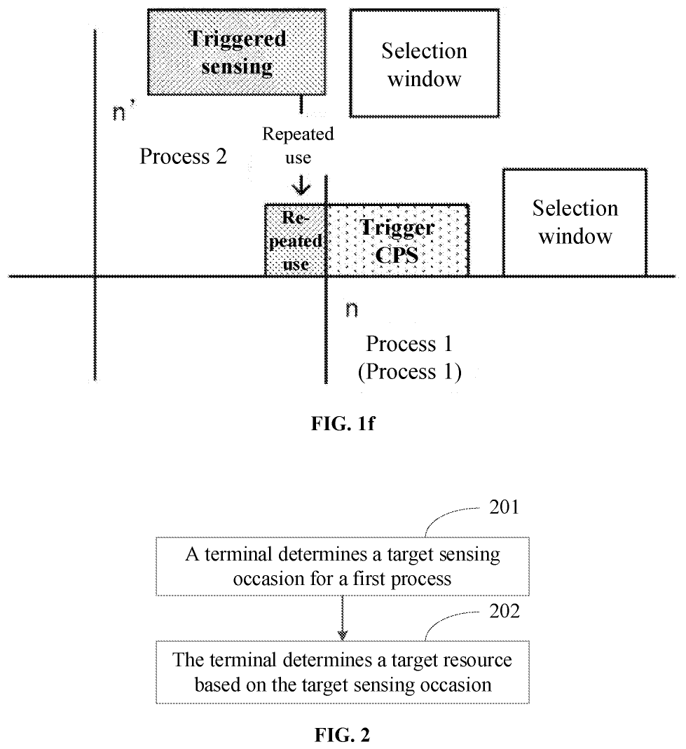

FIG. 1a is a block diagram of a wireless communication system to which an embodiment of this application can be applied. The wireless communication system includes a terminal 11 and a network side device 12. The terminal 11 may also be referred to as a terminal device or user equipment (UE). The terminal 11 maybe a terminal device such as a mobile phone, a tablet personal computer, a laptop computer or a notebook computer, a personal digital assistant (PDA), a palm computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), or a smart home device (a home device with a wireless communication function, such as a refrigerator, a television, a washing machine, or a furniture). The wearable device includes a smart watch, a smart band, a smart headset, smart glasses, smart jewelry (a smart bangle, a smart bracelet, a smart ring, a smart necklace, a smart anklet bracelet, or a smart anklet chain, or the like), a smart wrist strap, smart dress, a game console, and the like. It should be noted that a specific type of the terminal 11 is not limited in the embodiments of this application. The network side device 12 maybe a base station or a core network. The base station may be referred to as a NodeB, an evolved NodeB, an access point, a base transceiver station (BTS), a radio base station, a radio transceiver, a basic service set (BSS), an extended service set (ESS), a NodeB, an evolved NodeB (eNB), a home NodeB, a home evolved NodeB, a wireless local area network (WLAN) access point, a wireless fidelity (WiFi) node, a transmitting receiving point (TRP), or another suitable term in the field provided that a same technical effect is achieved. The base station is not limited to a specific technical term. It should be noted that, in the embodiments of this application, only a base station in an NR system is used as an example, but a specific type of the base station is not limited.

For better understanding of the solution provided in this application, the following content is described first:

### Sensing in LIE SL

A basic working principle of Long Term Evolution sidelink sensing (LTE sidelink sensing) is as follows:

As shown in FIG. 1b, measurement is performed in a sensing window, and scheduling assignment (SA) and interference measurement are performed in each transmission time interval (TTI) length. UE performs resource selection based on the following steps:
(1) excluding a resource used by the UE to send data;
(2) demodulating, by a terminal, received SA to obtain a resource reserved for another UE, and excluding the resource reserved for the another UE;
(3) performing energy detection within a sensing window, measuring a reference signal strength indication (RSSI), and excluding, based on a measurement result, a resource with large interference; and
(4) randomly selecting, from a selection window, one subframe from 20% resources with minimal interference for periodic resource reservation.

### Partial Sensing in LTE SL

Partial sensing in an LTE Vehicle to X (V2X) is mainly designed to save power, and is to support from Pedestrian to Vehicle (P2V) communication. Pedestrian user equipment (PUE) supports two resource selection modes. One is random resource selection. The other is to first perform partial sensing, select a resource based on a result of partial sensing, and perform semi-static resource reservation. A mode selected by the PUE is configured through Radio Resource Control (RRC), and when RRC is configured to support the two resource selection modes, the PUE decides a resource selection mode to use.

Specifically, a manner in which the terminal performs partial sensing and performs resource sensing is shown in FIG. 1c.

A sensing window of the PUE is a dot-filled part in a range [n-1000, n], a length Y and k are parameters configured through RRC, and a value range of k may be {1, 2, 3, . . . , 10}. A window filled with horizontal lines in [n+T1, n+T2] is a selection window of the PUE configured by a higher layer. The PUE senses, in a sensing window filled with vertical lines, sidelink control information (SCI) sent by another terminal, and speculates, based on the sensed SCI and a reservation period, a resource reservation situation of the another terminal in the sensing window filled with horizontal lines. The PUE may exclude, based on the information, a resource that does not meet a condition in a selection window. At least 20% of remaining resources (20% of a window length Y) are selected as a candidate resource set, and reported to a Medium Access Control (MAC) layer. The MAC layer randomly selects a resource from the candidate resource set as a candidate resource of the PUE. The PUE performs periodic reservation on the selected resource, and the reservation period is indicated in the SCI.

### Random Selection in Sidelink (SL) (Random Selection in SL)

If a user performs random selection, a resource is randomly selected within the selection window, and sensing does not need to be performed.

### Full Sensing in Sidelink (Full Sensing in NR SL)

In a resource assignment mode 2, the UE is supported to select a resource based on sensing. A principle is as follows:
(1) After resource selection is triggered, transmit user equipment (TX UE) determines a resource selection window.
(2) Before selecting a resource, the UE needs to determine candidate resources (candidate resource set) for resource selection. A specific implementation method is: comparing reference signal received power (RSRP) measured on a resource within the resource selection window with a corresponding RSRP threshold. If the RSRP is lower than an RSRP threshold, the resource may be included in the candidate resource set.
(3) After the resource set is determined, the UE randomly selects a transmission resource from the candidate resource set. In addition, the UE can reserve a transmission resource for a next transmission in the current transmission.

In an NR SL, the TX UE performs resource reservation on resources assigned to the TX UE (the reservation includes periodic reservation and aperiodic reservation). Reserved resources are used for future transmission of a physical sidelink control channel (PSCCH) and/or a physical sidelink share channel (PSSCH). The aperiodic reservation may be implemented based on a time resource assignment field in the SCI. The reserved resource can at least be used for transmission of a same transport block (TB). The periodic reservation may be implemented by using a resource reservation period field in the SCI, and periodic resources reserved in a current period may be used for transmission of a next TB. In R16, the UE is actually always performing sensing (for example, may be full sensing).

### Partial Sensing in NR in a new Radio (NR): In PBPS and CPS

In NR R17, due to a limited capability or a limited battery capacity, power-saving UE cannot continuously perform sensing (for example, may be full sensing) as UE in R16, and can only perform partial sensing or random resource selection. The power-saving UE also supports periodic partial sensing similar to that in LTE, which is referred to as periodic based partial sensing in NR, that is, PBPS.

In addition to possible PBPS, the UE may need to perform continuous sensing (for example, may be referred to as short terming sensing or continuous partial sensing) within a period of time [n+TA, n+TB], where TA and TB may be positive numbers, complex numbers, or 0. As shown in FIG. 1d, if a packet is received in a slot n, the UE determines a selection window, a resource set, or Y slots. To exclude a resource that may conflict with a resource reserved for another UE in the selection window, the resource set, or the Y slots, the UE determines a CPS window and a PBPS window that are corresponding to the selection window, the resource set, or the Y slots, and performs sensing in the CPS window and the PBPS window.

### Resource Pre-emption in SL (Resource Ore-emption in NR SL)

In the resource assignment mode 2, a resource pre-emption mechanism is supported. Brief descriptions of the mechanism are as follows: A resource reserved and/or selected by the UE overlaps (partially overlaps) with a resource reserved and/or selected by another UE with a higher priority service. If an SL-RSRP measurement value of the UE on an associated resource is greater than an associated SL-RSRP threshold, the UE triggers resource reselection. The service priority and the SL-RSRP threshold are determined by TB transmission on the resource.

As shown in FIG. 1e, to determine whether the reserved/selected resource

(PSCCH/PSSCH resources) is pre-empted, the UE performs resource selection re-evaluation at least at a moment “m−T3”, where a moment “m” is a moment at which the resource is located or a moment at which resource reservation information is sent, and T3 includes at least a duration of performing resource selection processing by the UE.

A method and an apparatus provided in the embodiments of this application are described in detail below with reference to the accompanying drawings based on specific embodiments and application scenarios thereof.

For ease of understanding, several terms (non-known terms, only for convenience of subsequent description) are defined:
1. Sensing occasion;

In this application, the sensing occasion may include a PBPS occasion and/or a CPS occasion. The occasion may be specifically a resource such as a window or a slot. Correspondingly, the sensing occasion may include a PBPS window, a CPS window, PBPS slots, and/or CPS slots. The sensing occasion may also be referred to as a sensing slot, a slot, a sensing window, a window, and the like. All types of cases are applicable to the technical solutions of this application. This is not specifically limited in the embodiments of this application.

For a procedure (for example, a process, resource selection triggered by an incoming packet, re-evaluation, and/or pre-emption evaluation), sensing slots in a PBPS window corresponding to the procedure are separately referred to as PBPS slots corresponding to the procedure, and sensing slots in a CPS window corresponding to the procedure are separately referred to as CPS slots corresponding to the procedure.

It should be noted that ‘PBPS window and/or CPS window corresponding to the procedure’ mentioned herein may be a PBPS window and/or a CPS window corresponding to PBPS and/or CPS that are assumed to be triggered, that is, it may be assumed that the procedure triggers PBPS and/or CPS (regardless of whether PBPS and/or CPS are actually triggered finally) and determines the corresponding PBPS window and/or CPS window; or may be a PBPS window and/or a CPS window corresponding to PBPS and/or CPS that are actually triggered. The expression “triggered sensing occasion” related above may be corresponding to the PBPS window and/or the CPS window that are assumed to be triggered, or may be corresponding to the PBPS window and/or the CPS window that are actually triggered.
2. Existing sensing occasion (existing sensing slot, or existing PBPS slot, or existing CPS slot)

If the procedure triggers PBPS and/or CPS, the UE needs to perform sensing. These sensing slots belong to a triggered PBPS and/or CPS slot. However, some sensing in a PBPS and/or CPS window corresponding to the procedure may be sensing of another procedure. In this case, these sensing slots of another procedure may be defined as existing sensing. For example, as shown in FIG. 1f, a process 2 triggers sensing for an incoming packet in a slot n′, and then at a moment in a slot n, there is a packet for a process 1, and sensing is triggered. In this case, the sensing triggered by the process 2 is completed, and a sensing window of the process 2 partially overlaps with a sensing window of the process 1. Therefore, a result of an overlapping part may be directly applied to the process 1. For the process 1, the sensing of the process 1 is existing sensing of the process 1. Therefore, ‘existing PBPS sensing slots corresponding to the procedure’ maybe PBPS sensing slots and/or CPS sensing slots of another procedure, and ‘existing CPS sensing slots corresponding to the procedure’ may also be PBPS sensing and/or CPS sensing slots of another procedure.

The PBPS and/or CPS slot may include the triggered PBPS slot and/or CPS slot, or may include the existing PBPS slot and/or the existing CPS slot.

In implementation of this application, all expression of “transmission” maybe interpreted as sending or receiving.

As shown in FIG. 2, an embodiment of this application provides a resource determining method. The method may be performed by a terminal. Specific steps include:
Step 201: The terminal determines a target sensing occasion for a first procedure.
Step 202: The terminal determines a target resource based on the target sensing occasion.

The target sensing occasion includes a first sensing occasion, or the target sensing occasion includes a first sensing occasion and a second sensing occasion, where the first sensing occasion is a sensing occasion corresponding to the first procedure, the second sensing occasion does not overlap with at least part of the first sensing occasion, at least part of the second sensing occasion corresponds to a second procedure, and the second procedure is a procedure different from the first procedure.

That at least part of the second sensing occasion corresponds to the second procedure means that at least part of the second sensing occasion may be corresponding to the second procedure, or at least part of the second sensing occasion may be corresponding to another procedure.

In a possible implementation, the sensing occasion includes one or more of the following:
(1) a PBPS occasion; and
(2) a CPS occasion.

It should be noted that a PBPS occasion and a CPS occasion corresponding to a same procedure may be overlapped. One slot may be in sensing occasions of a plurality of procedures at the same time. One slot may be in a PBPS occasion of a procedure and a CPS occasion of another procedure.

For example, a PBPS window and a CPS window corresponding to a same procedure may be overlapped, one slot may be in sensing windows of a plurality of procedures at the same time, and one slot may be in a PBPS window of a procedure and a CPS window of another procedure.

In this embodiment of this application, the first procedure may include categories such as process, resource selection triggered by an incoming packet, re-evaluation, and/or pre-emption evaluation. Similarly, the second procedure may also include categories such as process, resource selection triggered by an incoming packet, re-evaluation, and/or pre-emption evaluation.

In an actual application scenario, there may be a case in which the first procedure and the second procedure are corresponding to a same resource pool, for example, sensing, resource selection, reselection, re-evaluation, and pre-emption evaluation are triggered in a same resource pool.

The first procedure and the second procedure are not necessarily different processes, and may be a same HARQ process for different TBs. For example, resource selection corresponding to a TB1 of the process 1 and resource selection corresponding to a TB2 of the process 1 are different resource selection procedures.

The target resource may be one or more of an optional resource, an available resource, a candidate resource, an excluded resource, a re-evaluated resource, and a pre-empted resource.

The target sensing occasion may be referred to as an available sensing occasion (available sensing slots), the first sensing occasion may be referred to as second sensing slots, and the second sensing occasion may be referred to as existing sensing (for example, may be PBPS and/or CPS) slots and/or sensing slots corresponding to another procedure. It should be noted that the foregoing names are used for ease of describing the solution, and are not used as limitations on names of a specific feature.

First, a definition of the existing sensing slots is described as follows:

In an implementation, for a procedure, the existing slot is:
(1) an existing sensing slot that at least partially overlaps with PBPS slots and/or CPS slots corresponding to the procedure (referring to the foregoing first procedure, which may also be referred to as a current procedure or the procedure);

for example, an existing sensing slot in the PBPS slots corresponding to the procedure;
(2) a sensing slot that at least partially overlaps with a PBPS window and/or CPS window corresponding to the procedure;

for example, a sensing slot in the PBPS window corresponding to the procedure; and/or
(3) an existing sensing slot that at least partially overlaps with PBPS slots and/or CPS slots corresponding to another procedure (which may refer to the foregoing second procedure);

for example, an existing sensing slot in PBPS slots corresponding to another procedure;
(4) a sensing slot that at least partially overlaps with a PBPS window and/or CPS window corresponding to another procedure;

for example, an existing sensing slot in the PBPS window corresponding to the another procedure.

In an implementation, for a procedure, the existing sensing slot is:
(1) a sensing slot before a moment n or a moment m, where the moment n is a moment at which the first procedure is triggered, and the moment m is a moment in an available resource set (for example, may include a selection window, a remaining selection window, a set of Y slots (Y refers to a resource set shown in a white box in FIG. 1d), and/or a resource set) corresponding to the first procedure; and
(2) a sensing slot corresponding to another procedure but not triggered by the process.

In an implementation, for a procedure, the existing PBPS slot is:
(1) an existing sensing slot that at least partially overlaps with PBPS slots corresponding to the procedure;

for example, an existing sensing slot in the PBPS slots corresponding to the procedure;
(2) a sensing slot that at least partially overlaps with a PBPS window corresponding to the procedure;

for example, an existing sensing slot in the PBPS window corresponding to the procedure; and/or
(3) an existing sensing slot that at least partially overlaps with PBPS slots corresponding to another procedure;

for example, an existing sensing slot in PBPS slots corresponding to another procedure; and
(4) a sensing slot that at least partially overlaps with a PBPS window corresponding to another procedure;

for example, an existing sensing slot in the PBPS window corresponding to the another procedure.

(1) and (2) may be preferred implementations.

In an implementation, for a procedure, the existing CPS slot is any one of the following:
(1) an existing sensing slot that at least partially overlaps with CPS slots corresponding to the procedure;

for example, an existing sensing slot in the CPS slots corresponding to the procedure;
(2) a sensing slot that at least partially overlaps with a CPS window corresponding to the procedure;

for example, an existing sensing slot in the CPS window corresponding to the procedure; and/or
(3) an existing sensing slot that at least partially overlaps with CPS slots corresponding to another procedure;

for example, an existing sensing slot in the CPS slots corresponding to the another procedure;
(4) a sensing slot that at least partially overlaps with a CPS window corresponding to another procedure; and for example, a sensing slot in the CPS window corresponding to the another procedure.

(1) and (2) may be preferred implementations.

In a possible implementation, available sensing slots includes a first sensing slot and/or a second sensing slot, the second sensing slot is sensing slots triggered by the procedure, and the first sensing slot is an existing sensing slot and/or a sensing slot corresponding to another procedure.

In a possible implementation, the first sensing slot is available sensing slots, that is, the first sensing slot is equivalent to the second sensing slot plus the existing sensing slot.

In this embodiment of this application, the second sensing slots and the first sensing slots may be completely the same, may be partially the same, and may be different.

If the available sensing slots=the second sensing slots, only one step for determining sensing is essentially required.

Specifically, the following steps may be included: Step 1: Determine that Y of the process 1 and an assumed or triggered PBPS and/or CPS window needs to be monitored at least. Step 2: All available sensing in one or some windows may be used for resource exclusion.

For example,

(1) Step 1: Determine Y of the process 1 and determine second sensing. +Step 2: Determine first sensing, and perform resource exclusion based on the first sensing and the second sensing.

(2) Step 1: Determine Y of the process 1 and determine second sensing. +Step 2: Determine first sensing, and perform resource exclusion based on the first sensing.

(3) Only step 1 is performed, that is, Y of the process 1 is determined and the second sensing is determined; +resource exclusion is performed based on the second sensing.

(4) Only step 1 is performed, that is, Y of the process 1 is determined and the first sensing is determined; +resource exclusion is performed based on the first sensing.

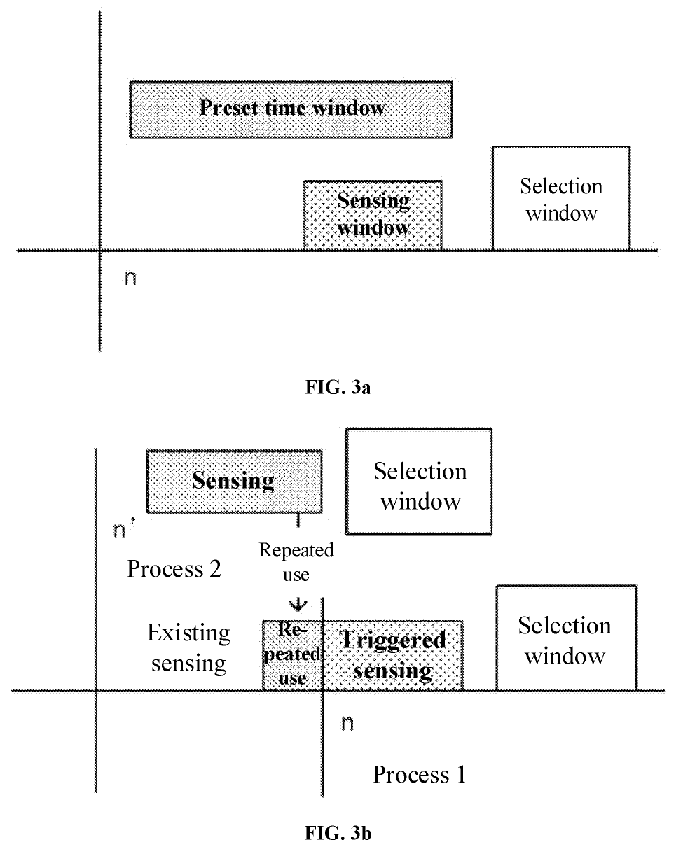

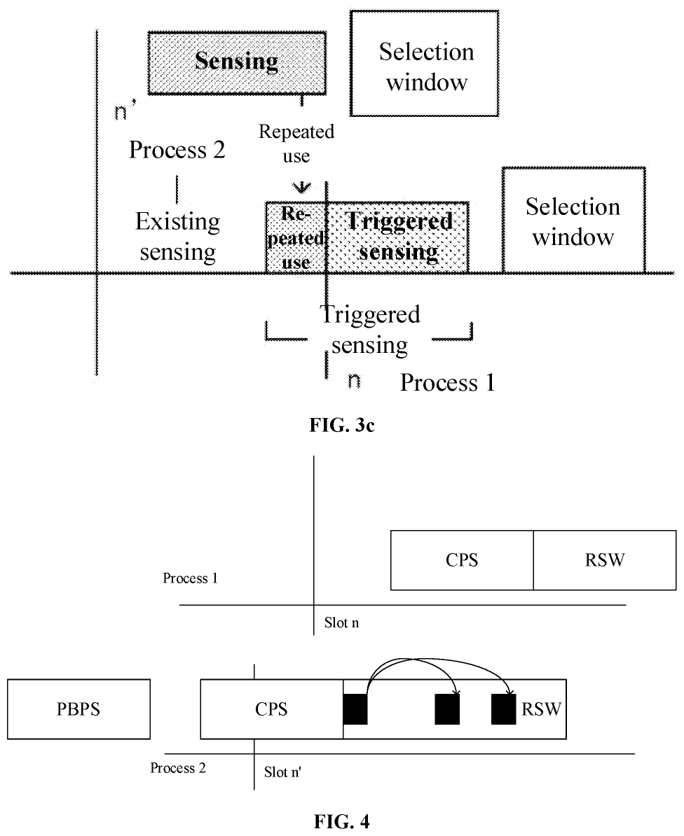

As shown in FIG. 3a, in specific implementation,

(1) a process is selected for a resource triggered in a slot n;

(1.1) The UE determines a selection window, a remaining selection window, a set of Y slots, and/or a resource set.

(1.2) The UE determines a second sensing slot, where the second sensing slot is a PBPS window and/or a CPS window (for example, may be corresponding to the procedure), and performs sensing in the sensing window.

An execution sequence of (1.1) and (1.2) is not limited.

(2) The UE determines available sensing slots, where the available sensing slots are slots in which sensing can be performed in a preset time window.

(2.1) In an implementation, the preset time window is slot n—T0 to slot n— processing time0. Optionally, the processing time is Tproc0. Optionally, T0 is a value that can be configured or preconfigured or specified in a protocol.

(2.2) In an implementation, the preset time window is related to a selection window/remaining selection window/set of Y/resource set, and is specifically from a start point—T4 to the start point—processing time1. Optionally, the processing time1 includes at least time required for decoding SCI and/or time required for reporting a target resource, for example, Tproc0+Tproc1. Optionally, T4 is a value that configured or preconfigured or specified in a protocol.

(3) The UE determines, based on the available sensing slots, whether there is a resource conflict between a reserved resource of another UE and a resource in the selection window/remaining selection window/set of Y slots/resource set.

This application further includes a concept of a triggered sensing occasion. For a procedure, the triggered sensing occasion is:
(1) PBPS slots and/or CPS slots of the procedure (for example, may be assumed or triggered); and
(2) at least part of sensing slots of a PBPS window and/or a CPS window of the procedure (for example, may be assumed or triggered).

In some embodiments, the triggered sensing occasion and the existing slot are not overlapped. As shown in FIG. 3b, for the process 1, a reused part belongs to existing, and a non-reused part is the triggered sensing occasion.

In some embodiments, the triggered sensing occasion includes the existing slot, for example, including the existing sensing slot and a slot in which sensing needs to be additionally performed after sensing is triggered. As shown in FIG. 3c, for the process 1, reused triggered sensing occasions include a reused part and a sensing slot in which sensing is additionally performed.

In a possible implementation, the target sensing occasion includes one or more of the following:

(1) A preset occasion within a preset time range, where the preset time range is any one of preset time, a preset time window, and a preset timer, and the preset time is any one of an occasion, a sensing occasion, an SL occasion, an SL occasion that is not used for transmission of a synchronization signal, an occasion other than a non-monitor occasion, and an SL occasion in a resource pool (the resource pool may be any resource pool or may be a resource pool corresponding to the procedure).

Optionally, the preset time range meets one or more of the following:

(1.1) Duration of the preset time range is 31 slots, 32 slots, 1 second, 100 slots, 1000 slots, a minimum value CPSmin of a quantity of CPS occasions, a quantity Y of resources in an available resource set corresponding to the first procedure, a minimum value Ymin of a quantity of resources in an available resource set, duration greater than or equal to CPSmin, duration greater than or equal to Y, or duration greater than or equal to Ymin, where CPSmin is a minimum value of the quantity of CPS occasions (which may also be interpreted as a minimum value of a CPS window size), Y is the quantity of resources in the available resource set, for example, is a quantity of resources in the available resource set corresponding to the first procedure, Ymin is a minimum value of the quantity of resources in the available resource set, and Ymin is not limited to a procedure, and may be corresponding to all procedures.

(1.2) Duration, a start point, and/or an end point of the preset time range are determined based on a preset period value.

For example, based on a reservation period value or a Preserve value (that is, a reservation period value used to determine a PBPS occasion, which is assumed as P), it is determined that the start point is n−P*i, or the start point is not later than n−P*i. In an implementation, P is a maximum reservation period value or a maximum Preserve value, and optionally, the maximum value is a maximum value in configurable values or defined values/allowed values.

For another example, the duration is i*max Preserve or j*max reservation period or max(K*Preserve) or max(K*Preserve, i*max Preserve, j*max reservation period), where Preserve is a reservation period value configured/preconfigured to determine a PBPS window, max Preserve is a maximum value in these values, reservation period is a configured/preconfigured reservation period value, max reservation period is a maximum value in these values, one Preserve has one corresponding PBPS window number, and max(K*Preserve) is a maximum value in all K and corresponding Preserve products.

(1.3) The start point of the preset time range is a moment n, the start point of the preset time range is a moment obtained by the moment n plus a first preset offset, or the start point of the preset time range is a moment obtained by the moment n minus a second preset offset, where the moment n is a moment at which the first procedure is triggered.

(1.4) The end point of the preset time range is a moment m, the end point of the preset time range is a moment obtained by the moment m plus a third preset offset, or the end point of the preset time range is a moment obtained by the moment m minus a fourth preset offset, where the moment m is a (for example, may be a specific or any) moment in the available resource set corresponding to the first procedure.

(1.5) The start point of the preset time range is a moment of a start point determined based on the preset period value plus a fifth preset offset, or the start point of the preset time range is a moment of a start point determined based on the preset period value minus a sixth preset offset.

(1.6) The end point of the preset time range is a moment of an end point determined based on the preset period value plus a seventh preset offset, or the end point of the preset time range is a moment of a start point determined based on the preset period value minus an eighth preset offset.

Optionally, (for example, when the procedure may be a re-evaluation and/or pre-emption procedure), an end point of the preset time, the preset time window, and/or the preset timer is the moment n, the moment n+ an offset, or the moment n− an offset.

Optionally, an end point of the preset time, the preset time window, and/or the preset timer is the moment n− processing time or the moment m− processing time, and processing time is processing time. Specifically, the processing time is greater than or equal to time required for decoding SCI and/or time required for reporting a target resource. The time required for reporting the target resource may include time required for preparing to perform reporting, that is, processing time includes the time required for decoding SCI and/or time required for preparing to report the target resource, or processing time is not less than the time required for decoding SCI and/or time required for preparing to report the target resource, for example, processing time=Tproc1 +Tproc0.

(1.7) The start point of the preset time range is a moment n′, the start point of the preset time range is a moment obtained by the moment n′ plus a ninth preset offset, or the start point of the preset time range is a moment obtained by the moment n′ minus a tenth preset offset, where the moment n′ is a triggering moment of a resource selection or reselection procedure corresponding to the first procedure, or the moment n′ is a moment in the available resource set corresponding to the first procedure, or the moment n′ is a moment of reporting the available resource set or a target resource corresponding to the first procedure. For example, the moment n′ is the first slot or the first ms in the available resource set corresponding to the first procedure.

(1.8) The start point and the end point of the preset time range are spaced apart by an eleventh preset offset. Optionally, the eleventh preset offset is any one of 31 slots, 32 slots, 1second, 100 slots, l000 slots, CPSmin, Y, or Ymin.

The end point of the preset time range is an end moment of a packet delay budget (PDB), the end point of the preset time range is a moment of the end moment of the PDB minus a preset offset, or the end point of the preset time range is a moment of the end moment of the PDB plus the preset offset.

For example, the end point is a slot in which a start point of the selection window is located—1000 slots to the start point of the selection window—processing time.

For example, the end point is a slot in which a start point of the set of Y is located—1000 slots to the start point of the set of Y—processing time, and is represented as [ty0−1000, ty0—processing time], where ty0 is the first slot of Y.

For example, the end point is the first slot of the set of Y−31 to the first slot of Y-processing time, and is represented as [ty0—31, ty0—processing time], where ty0 is the first slot of Y.

It should be noted that, the preset time range may be determined based on one or more of the foregoing (1.1) to (1.8). When a plurality of items are involved, a maximum value or a minimum value of the plurality of items may be selected.

(2) A sensing occasion corresponding to the first procedure, for example, PBPS slots, a PBPS window, CPS slots, and/or a CPS window.

(3) A sensing occasion corresponding to the second procedure, for example, PBPS slots, a PBPS window, CPS slots, and/or a CPS window.

(4) A triggered sensing occasion corresponding to the first procedure, such as triggered PBPS slots, a triggered PBPS window, triggered CPS slots, and/or a triggered CPS window.

(5) Existing PBPS slots and/or an existing PBPS window (for example, corresponding to the first procedure).

Optionally, for an unpredictable procedure or aperiodic transmission, this item is not considered for available sensing slots (that is, a target sensing occasion), and only (1) to (4) are considered.

(6) Existing CPS slots and/or an existing CPS window (for example, corresponding to the first procedure).

Optionally, for an unpredictable procedure or aperiodic transmission, this item is not considered for available sensing slots (that is, a target sensing occasion), and only (1) to (4) are considered.

(7) A sensing occasion determined by the terminal, that is, the UE determines and/or implements the sensing occasion, and a specific condition does not need to be met.

In a possible implementation, in a case that the first preset condition is met, the target sensing occasion includes a second sensing occasion, that is, when the first preset condition is met, the available sensing slots include the existing sensing (for example, PBPS and/or CPS) slots and/or sensing occasions (for example, PBPS slots and/or CPS slots) corresponding to another procedure, that is, the foregoing (3), (6), and (7). Alternatively, the existing sensing slots described as the first preset condition and/or the sensing slots corresponding to another procedure may be used as the available sensing slots.

In this embodiment of this application, in a case that the first preset condition is met, the target sensing occasion includes a first sensing occasion and a second sensing occasion, or a second sensing occasion described as meeting the first preset condition can be used for the target sensing occasion.

The first preset condition includes one or more of the following:
(1) The second sensing occasion is within a preset time range, where the preset time range is any one of preset time, a preset time window, or a preset timer.

In this case, it may also be interpreted as that existing sensing slots that meet a condition that the target sensing occasion includes a preset occasion in the preset time range and/or sensing slots corresponding to another procedure may be used as the available sensing slots.
(2) A gap between the second sensing occasion and a moment n is greater than or equal to the processing time, where the moment n is a moment at which the first procedure is triggered, and the processing time is greater than or equal to time required for decoding sidelink control information SCI and/or time required for reporting a target resource.
(3) A gap between the second sensing occasion and the moment n is greater than or equal to the processing time.
(4) The second sensing occasion is in a K PBPS occasion (for example corresponding to one or more periodic values), where K is a preset value.

Optionally, K may have one or more values, that is, there may be one or more occasions, and K may be configured/preconfigured/specified in a protocol/indicated by a higher layer/determined by the UE. The occasion may be window, and therefore, there are one or more PBPS windows.

Optionally, the period value may be configured, preconfigured, specified in a protocol, indicated by a higher layer, and/or determined by the UE.

For example, it is configured and/or pre-configured that the UE needs to perform sensing within the nearest and/or last PBPS slot and last but second PBPS slot. If existing slots are the latest and/or last but two PBPS slot of the procedure, then existing slots are unavailable. If existing slots are the nearest and/or last PBPS slot and last but one PBPS slot of the procedure, the existing slots are available.
(5) An overlapping part between the second sensing occasion and the first sensing occasion is less than or equal to a first threshold, or the overlapping part is greater than or equal to a second threshold, or a proportion of the overlapping part to the first sensing occasion is less than or equal to a first proportion, or a proportion of the overlapping part to the first sensing occasion is greater than or equal to a second proportion.
(6) A non-overlapping part between the first sensing occasion and the second sensing occasion is less than or equal to a third threshold, or the non-overlapping part is greater than or equal to a fourth threshold, or a proportion of the non-overlapping part to the first sensing occasion is less than or equal to a third proportion, or a proportion of the non-overlapping part to the first sensing occasion is greater than or equal to a fourth proportion.
(7) An available resource set corresponding to the second sensing occasion and the available resource set corresponding to the first sensing occasion at least partially overlap.
(8) A quantity of resources in an overlapping part between the available resource set corresponding to the second sensing occasion and the available resource set corresponding to the first sensing occasion is less than or equal to a fifth threshold, or the quantity of resources in the overlapping part is greater than or equal to a sixth threshold, or a proportion of the quantity of resources in the overlapping part to the available resource set corresponding to the second sensing occasion or the available resource set corresponding to the first sensing occasion is less than or equal to a fifth proportion, or a proportion of the overlapping part to the available resource set corresponding to the second sensing occasion or the available resource set corresponding to the first sensing occasion is greater than or equal to a sixth proportion.
(9) The second sensing occasion and/or the triggered sensing occasion meet a preset condition for triggering sensing. In other words, it may be understood as that if triggered sensing is met, it is considered that the target sensing occasion includes the second sensing occasion.
(10) A condition for determining a PBPS occasion and/or triggering PBPS.
(11) A condition for determining a CPS occasion and/or triggering CPS.
(12) A quantity of trigger sensing occasions is greater than or equal to a first value.

Optionally, CPS is used as an example. In this case, a start point of a CPS window or a start point of triggered CPS slots (that is, the first slot or sensing slot, denoted as n+TA) is equal to or later than (or may be understood as being greater than) the moment n; or TA>=0.
(13) A sum of a quantity of second sensing occasion and a quantity of triggered sensing occasions is greater than or equal to a second value.

Optionally, CPS is used as an example. In this case, a start point of a CPS window or a start point (that is, the first slot or sensing slot, denoted as n+TA) of triggered CPS slots is equal to or later than the moment n; or TA>0;

Optionally, CPS is used as an example. In this case, a start point of a CPS window or a start point (that is, the first slot or sensing slot, denoted as n+TA) of triggered CPS slots is the earliest slot in existing (CPS) sensing slots and triggered (which may be, for example, CPS) sensing slots, or is not later than the slot.

CPS is used as an example. In a possible scenario, a packet PDB is too small to determine a CPS window that is after the moment n and that meets CPSmin. However, before the moment n, there is existing CPS. It is assumed that a CPS window that meets CPSmin may be determined after the existing CPS is used, so that CPS can still be triggered.
(14) The quantity of second sensing occasions is greater than or equal to a third value.

Optionally, CPS is used as an example. In this case, a start point of a CPS window or a start point (that is, the first slot or sensing slot, denoted as n+TA) of triggered CPS slots is the earliest slot in existing (for example, may be CPS) sensing slots, or is not later than the slot.
(15) A quantity of preset occasions is greater than or equal to a fourth value.
(16) A quantity of sensing occasions determined by the terminal is greater than or equal to a fifth value.

In other words, the UE can find and/or determine a CPS window in which a quantity of sensing slots is not less than the fifth value, or the UE can find and/or determine sensing slots whose quantity is not less than the fifth value.

CPS is used as an example. The UE defines a solution in which n+TA and it is ensured that the CPS window meets a min size. How to perform determining is not specified in a protocol.
(17) A quantity of preset occasions in available resource set determined by the terminal is greater than or equal to a sixth value.

In other words, the UE can find and/or determine a selection window, a remaining selection window, a set of Y, and/or a resource set, where the selection window, the remaining selection window, the set of Y, a resource in the resource set, a slot, a sensing slot, an SL slot, an SL slot that is not used for transmission of a synchronization signal, a slot other than a non-monitor occasion (i.e. non-monitor slot), and/or a quantity of SL slots in a resource pool is not less than the sixth value.
(18) At least part of a first reservation period value is less than a seventh value.
(19) At least part of a second reservation period value used to determine the PBPS occasion is less than an eighth value, where the second reservation period is a Preserve value used to determine the PBPS occasion.
(20) A non-overlapping part between the PBPS occasion and the CPS occasion is greater than or equal to a ninth value, or a proportion of the non-overlapping part to the PBPS occasion is greater than or equal to a ninth proportion.
(21) A non-overlapping part between the PBPS occasion and the second sensing occasion is greater than or equal to a tenth value, or a proportion of the non-overlapping part to the PBPS occasion is greater than or equal to a tenth proportion.
(22) A quantity of overlapping parts between the PBPS occasion and the CPS occasion is less than or equal to an eleventh value, or a proportion of the overlapping parts to the PBPS occasion is less than or equal to an eleventh proportion.
(23) A quantity of overlapping parts between the PBPS occasion and the second sensing occasion is less than or equal to a twelfth value, or a proportion of the overlapping parts to the PBPS occasion is greater than or equal to a twelfth proportion.
(24) At least part of occasions in PBPS occasions are not overlapped, or an overlapping part between the at least part of occasions is less than a thirteenth value, or a proportion of the overlapping part between the at least part of occasions to the PBPS occasions is less than a thirteenth proportion.
(24.a) A third preset condition is not met, where content of the third preset condition may include one or more of the foregoing (18) to (24). Optionally, that the third preset condition is not met is applicable to a CPS scenario.
(25) At least part of a third reservation period value is greater than or equal to an eighteenth value.
(26) At least part of a fourth reservation period value used to determine the PBPS occasion is greater than or equal to a nineteenth value.
(27) A non-overlapping part between the CPS occasion and the PBPS occasion is greater than or equal to a twentieth value, or a proportion of the non-overlapping part to the CPS occasion is greater than or equal to a twentieth proportion.
(28) A non-overlapping part between the CPS occasion and the second sensing occasion is greater than or equal to a twenty-first value, or a proportion of the non-overlapping part to the CPS occasion is greater than or equal to a twenty-first proportion.
(29) A quantity of overlapping parts between the CPS occasion and the PBPS occasion is less than or equal to a twenty-second value, or a proportion of the overlapping parts to the CPS occasion is less than or equal to a twenty-second proportion.
(30) A quantity of overlapping parts between the CPS occasion and the second sensing occasion is less than or equal to a twenty-third value, or a proportion of the overlapping parts to the CPS occasion is less than or equal to a twenty-third proportion.
(31) At least part of occasions in CPS occasions are not overlapped, or an overlapping part between the at least part of occasions is greater than or equal to a twenty-fourth value, or a proportion of the overlapping part between the at least part of occasions to the CPS occasions is greater than or equal to a twenty-fourth proportion.
(32) A quantity of preset occasions in the available resource set is less than or equal to i×p—processing time, where i is a positive integer, and P is a fifth reservation period value, or P is a sixth reservation period value used to determine the PBPS occasion.

In other words, a quantity of slots in a minimum selection window (for example, corresponding to the procedure), a remaining selection window, a set of Y, a resource in the resource set, a slot, a sensing slot, an SL slot, a slot that is not used for transmission of a synchronization signal, a slot other than a non-monitor slot, and/or an SL slot in a resource pool is less than or equal to i×P—processing time, where P is a specific or any Preserve, and P is a specific or any reservation period value.
(33) There is no sensing occasion in the preset time period, or the sensing occasion is less than a preset value, or the sensing occasion does not correspond to the first procedure (for example, the procedure may be resource re-evaluation or pre-emption).

Optionally, the foregoing sensing occasion is sensing slots or existing slots corresponding to another procedure.

Optionally, this rule is applicable to CPS.
(33.a) A fourth preset condition is not met, where content of the fourth preset condition may include one or more of the foregoing (25) to (33). Optionally, that the fourth preset condition is not met is applicable to a PBPS scenario.
(34) The second sensing occasion and/or the triggered sensing occasion meet a preset condition for not triggering sensing. This case means that sensing is not triggered subsequently due to a limitation on a size of the sensing occasion or a limitation on a corresponding optional resource. Although sensing is not triggered, this case still meets a condition that the target sensing occasion includes second sensing time.
(34.a) A fifth preset condition is not met, where content of the fifth preset condition may include one or more of the foregoing (18) to (24) and (25) to (33). Optionally, that the fifth preset condition is not met is applicable to the foregoing scenario in which the target sensing occasion includes second sensing time but sensing is not triggered subsequently.

It should be noted that, in some implementations, the foregoing (32) that the quantity of preset occasions in the available resource set is less than or equal to the i×P—processing time may also be applicable to the scenario in which the target sensing occasion includes second sensing time but sensing is not triggered subsequently. Specifically, the quantity of preset occasions in the available resource set is less than or equal to the h×p—processing time, where h is a positive integer, that is, different coefficients are used for different scenarios.
(35) At least part of sensing occasions are continuous, and a quantity of sensing occasions or a quantity of continuous sensing occasions exceeds a seventh threshold.
(36) A condition determined by the terminal.

It should be noted that the Nvalues involved in the foregoing conditions may be the same or different from each other, and may be set based on an actual requirement. Other N^{th} proportions and N^{th} thresholds are similar to this, and are not repeated.

In a possible implementation, in a case that the second preset condition is met, the target sensing occasion does not include the second sensing occasion. In other words, when the second preset condition is used, the available sensing slots do not include the existing (for example, PBPS/CPS) slots and/or the sensing slots corresponding to another process, or this is described as that existing sensing (for example, PBPS/CPS) slots that meet the second preset condition and/or the sensing slots corresponding to the another process cannot be used as the available sensing slots.

In this embodiment of this application, in a case that the second preset condition is met, the target sensing occasion does not include the second sensing occasion, or this is described as that the second sensing occasion that meets the first preset condition cannot be used as the target sensing occasion.

The second preset condition includes one or more of the following:
(1) One or more conditions in the first preset condition are not met.
(2) At least part of reserved resources corresponding to the second sensing occasion are excluded. In other words, the corresponding reserved resources are resources that are determined to, has been, or may be excluded.

For example, the UE selects a slot used for transmission, or the UE reserves the slot. If the sensing slots corresponding to the slot overlap with the existing slots, at least an overlapping part cannot be used.
(3) The second sensing occasion is a non-monitor occasion.
(4) The second sensing occasion at least partially overlaps with an occasion used by the terminal to perform SL sending.
(5) The second sensing occasion at least partially overlaps an occasion used by the terminal to perform non-SL sending or receiving, where the non-SL may be specifically interpreted as sending or receiving by using a Uu interface.
(6) The second sensing occasion does not overlap with the sensing occasion corresponding to the first procedure.
(7) An overlapping part between the second sensing occasion and the first sensing occasion is less than or equal to an eighth threshold, or the overlapping part is greater than or equal to a ninth threshold, or a proportion of the overlapping part to the first sensing occasion is less than or equal to a seventh proportion, or a proportion of the overlapping part to the first sensing occasion is greater than or equal to an eighth proportion.
(8) The second sensing occasion and/or the triggered sensing occasion do not meet a preset condition for triggering sensing.
(9) The second sensing occasion and/or the triggered sensing occasion meet a preset condition for not triggering sensing.
(10) A condition for determining the PBPS occasion and/or triggering PBPS is not met.
(11) A condition for determining the CPS occasion and/or triggering CPS is not met.
(11.a) A sixth preset condition is not met, where content of the sixth preset condition may include one or more of (18) to (24) and (25) to (33) in the foregoing first preset condition.

In this embodiment of this application, it is considered that if the target sensing occasion does not include the second sensing occasion, it may be understood as that sensing is not triggered.
(12) At least part of sensing occasions are continuous, and a quantity of sensing occasions or a quantity of continuous sensing occasions exceeds a tenth threshold.
(13) A quantity of preset occasions in the available resource set is less than or equal to j×P—processing time, where j is a positive integer, and P is a ninth reservation period value, or P is a tenth reservation period value used to determine the PBPS occasion.

In other words, a quantity of slots in the minimum selection window (for example, corresponding to the procedure), the remaining selection window, the set of Y, the resource in the resource set, the slot/sensing slot, the SL slot, the SL slot that is not used for transmission of a synchronization signal, the slot other than the non-monitor slot, and/or the SL slot in the resource pool is less than or equal to j×P—processing time, where P is a specific or any Preserve, P is a specific or any reservation period value, and the quantity of SL slots in the minimum selection window, the remaining selection window, the set of Y, the resource in the resource set, the slot/sensing slot, the SL slot, the SL slot that is not used for transmission of a synchronization signal, the slot other than the non-monitor slot, and/or the SL slot in the resource pool is greater than or equal to j×P.

It should be noted that the N^{th}values involved in the foregoing conditions may be the same or different from each other, and may be set based on an actual requirement. Other N^{th} proportions and N^{th} thresholds are similar to this, and are not repeated.

In a possible implementation, the method further includes: the terminal determines a first sensing occasion and/or an available resource set.

Specifically, that the terminal determines the first sensing occasion includes one or more of the following:
(1) PBPS slots (for example, corresponding to the procedure/triggered);
(2) CPS slots (for example, corresponding to the procedure/triggered);
(3) a PBPS window (for example, corresponding to the procedure/triggered); and
(4) a CPS window (for example, corresponding to the procedure/triggered).

Specifically, that the terminal determines the first sensing occasion includes: a selection window, a remaining selection window, a set of Y, and/or a resource set (for example, corresponding to the procedure).

In a possible implementation, that the terminal determines the target resource based on the target sensing occasion includes:

the terminal performs exclusion for periodic reservation and exclusion for aperiodic reservation based on the target sensing occasion.

In this embodiment of this application, regardless of whether a sensing slot is in the

CPS window or the PBPS window, whether periodic and aperiodic reservation resources of the sensing slot conflict with a current procedure needs to be checked. In this way, processing behavior of all sensing slots is consistent, so that the resource exclusion is more comprehensive and reliable.

In a possible implementation, the target sensing occasion includes a first set and/or a second set. Optionally, the first set may also be referred to as a CPS set, and the second set may also be referred to as a PBPS set.

The first set is at least part of the CPS occasion corresponding to the first procedure and/or at least part of the CPS occasion corresponding to the second procedure.

The second set is at least part of the PBPS occasion corresponding to the first procedure and/or at least part of the PBPS occasion corresponding to the second procedure.

In a possible implementation, that the terminal determines the target resource based on the target sensing occasion includes one or more of the following:
the terminal performs exclusion for aperiodic reservation based on a sensing occasion in the first set; and
the terminal performs exclusion for periodic reservation based on a sensing occasion in the second set, or the terminal performs exclusion for periodic reservation and exclusion for aperiodic reservation based on a sensing occasion in the second set.

Specifically, exclusion for periodic reservation is performed based on a sensing slot in the PBPS set in the available sensing slots (for example, may be a resource in the selection window, the remaining selection window, the set of Y, and/or the resource set), and/or exclusion for aperiodic reservation is performed based on a sensing slot in the CPS set in the target sensing slots (for example, may be a resource in the selection window, the remaining selection window, the set of Y, and/or the resource set).

In this method, exclusion for periodic reservation and exclusion for aperiodic reservation are separately performed based on classifications, so that exclusion for periodic reservation is avoided for some slots that cannot provide useful periodic reservation information, or exclusion for aperiodic reservation is avoided for some slots that provide useful aperiodic reservation information.

Alternatively, exclusion for periodic reservation and exclusion for aperiodic reservation are performed based on the sensing slot in the PBPS set in the available sensing slots (for example, may be a resource in the selection window, the remaining selection window, the set of Y, and/or the resource set), and/or exclusion for aperiodic reservation is performed based on the sensing slot in the CPS set in the target sensing slots (for example, may be a resource in the selection window, the remaining selection window, the set of Y, and/or the resource set).

Further, the foregoing performing periodic exclusion may be performed based on a reservation period and/or a resource indication field, and the foregoing performing aperiodic exclusion may be replaced with performing exclusion based on a resource indicator information (TFRI) field.

Further, periodic exclusion is performed based on a resource corresponding to a reservation period and/or a resource indicator information field (TFRI field), and aperiodic exclusion is performed based on a resource corresponding to the resource indicator field (TFRI field).

In a possible implementation, the method further includes:
the terminal performs periodic exclusion and/or aperiodic exclusion based on a non-monitor occasion.

For example, aperiodic reservation of the non-monitor slot in the CPS window at least partially overlaps with a resource in the selection window, the remaining selection window, the set of Y, and/or the resource set, so that the resource may need to be excluded.

The non-monitor slot may be a resource reserved and/or selected by the procedure or another procedure.

For details, refer to FIG. 4. For non-monitor slots, some resources in a CPS window after the moment n of the procedure 1 are selected or reserved by the procedure 2. In this case, when the target resource is determined, periodic reservation and aperiodic reservation of these resources may need to be excluded. RSW is a selection window (resource selection window).

In some implementations, if PBPS is executed or triggered for a procedure, behavior of the UE includes at least one of the following:
1. The UE determines an RSW and/or a set of Y slots, where Y>=Ymin.
2. The UE performs sensing in a PBPS window or a PBPS occasion corresponding to the set of Y slots.
3. A preliminary available resource set SA is obtained based on resource initialization in the set of Y slots.

In some implementations, if CPS is executed or triggered for a procedure, behavior of the UE includes at least one of the following:
1. The UE determines an RSW and/or a set of Y′ slots. Further, optionally, Y′>=Ymin′.

(a) If PBPS is also executed or triggered for this procedure, an implementation method is Y′=Y, and/or Ymin′=Ymin. Otherwise, Ymin is a value configured by a base station, (pre-)configured, or indicated by a higher layer, and a value indicated by another UE. Y′ is a quantity of resources or a preset quantity of occasions in an available resource set corresponding to CPS, Y′min is a minimum value of the quantity of resources or the preset quantity of occasions in the available resource set corresponding to CPS, Y is a quantity of resources or a preset quantity of occasions in an available resource set corresponding to PBPS, and Ymin is a minimum value of the quantity of resources or the preset quantity of occasions in the available resource set corresponding to PBPS.
2. The UE performs sensing in a CPS window or a CPS occasion corresponding to the set of Y′ slots.
3. A preliminary available resource set SA is obtained based on resource initialization in the set of Y′ slots.

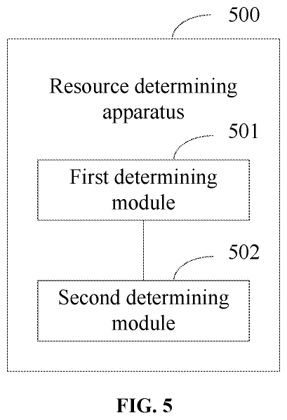

As shown in FIG. 5, an embodiment of this application provides a resource determining apparatus 500, and the apparatus includes:
a first determining module 501, used by a terminal to determine a target sensing occasion for a first procedure; and
a second determining module 502, used by the terminal to determine a target resource based on the target sensing occasion; where
the target sensing occasion includes a first sensing occasion, or the target sensing occasion includes a first sensing occasion and a second sensing occasion, where the first sensing occasion is a sensing occasion corresponding to the first procedure, the second sensing occasion does not overlap with at least part of the first sensing occasion, at least part of the second sensing occasion corresponds to a second procedure, and the second procedure is a procedure different from the first procedure.

In a possible implementation, the target sensing occasion includes one or more of the following:
a preset occasion within a preset time range, where the preset time range is any one of preset time, a preset time window, or a preset timer, and the preset occasion is any one of an occasion, a sensing occasion, an SL occasion, an SL occasion that is not used for transmission of a synchronization signal, an occasion other than a non-monitor occasion, or an SL occasion in a resource pool;
a sensing occasion corresponding to the first procedure;
a sensing occasion corresponding to the second procedure;
a triggered sensing occasion corresponding to the first procedure; and
a sensing occasion determined by the terminal.

In a possible implementation, the sensing occasion includes one or more of the following:
a PBPS occasion; and
a CPS occasion

In a possible implementation, the preset time range meets one or more of the following:

duration of the preset time range is 31 slots, 32 slots, 1 second, 100 slots, 1000 slots, a minimum value CPSmin of a quantity of CPS occasions, a quantity Y of resources in an available resource set corresponding to the first procedure, a minimum value Ymin of the quantity of resources in the available resource set, duration greater than or equal to CPSmin, duration greater than or equal to Y, or duration greater than or equal to Ymin;
duration, a start point, and/or an end point of the preset time range are determined based on a preset period value;
the start point of the preset time range is a moment n, the start point of the preset time range is a moment obtained by the moment n plus a first preset offset, or the start point of the preset time range is a moment obtained by the moment n minus a second preset offset, where the moment n is a triggering moment of the first procedure;
the end point of the preset time range is a moment m, the end point of the preset time range is a moment obtained by the moment m plus a third preset offset, or the end point of the preset time range is a moment obtained by the moment m minus a fourth preset offset, where the moment m is a moment in the available resource set corresponding to the first procedure;
the start point of the preset time range is a moment of a start point determined based on the preset period value plus a fifth preset offset, or the start point of the preset time range is a moment of the start point determined based on the preset period value minus a sixth preset offset;
the end point of the preset time range is a moment of an end point determined based on the preset period value plus a seventh preset offset, or the end point of the preset time range is a moment of the end point determined based on the preset period value minus an eighth preset offset;
the start point of the preset time range is a moment n′, the start point of the preset time range is a moment obtained by the moment n′ plus a ninth preset offset, or the start point of the preset time range is a moment obtained by the moment n′ minus a tenth preset offset, where the moment n′ is a triggering moment of a resource selection or reselection procedure corresponding to the first procedure, or the moment n′ is a moment in the available resource set corresponding to the first procedure, or the moment n′ is a reporting moment of the available resource set or a target resource corresponding to the first procedure;
the start point and the end point of the preset time range are spaced apart by an eleventh preset offset; and
the end point of the preset time range is an end moment of a packet delay budget PDB, the end point of the preset time range is a moment of the end moment of the PDB minus a preset offset, or the end point of the preset time range is a moment of the end moment of the PDB plus the preset offset.

In a possible implementation, in a case that a first preset condition is met, the target sensing occasion includes the first sensing occasion and the second sensing occasion; and the first preset condition includes one or more of the following:
the second sensing occasion is within a preset time range, where the preset time range is any one of preset time, a preset time window, or a preset timer;
a gap between the second sensing occasion and a moment n is greater than or equal to processing time, where the moment n is a triggering moment of the first procedure, and the processing time is greater than or equal to time required for decoding sidelink control information SCI and/or time required for reporting a target resource;
the gap between the second sensing occasion and the moment n is greater than or equal to the processing time;
the second sensing occasion is located in a K^{th} PBPS occasion, where K is a preset value;
an overlapping part between the second sensing occasion and the first sensing occasion is less than or equal to a first threshold, or the overlapping part is greater than or equal to a second threshold, or a proportion of the overlapping part to the first sensing occasion is less than or equal to a first proportion, or a proportion of the overlapping part to the first sensing occasion is greater than or equal to a second proportion;
a part that is in the first sensing occasion and that does not overlap with the second sensing occasion is less than or equal to a third threshold, or the non-overlapping part is greater than or equal to a fourth threshold, or a proportion of the non-overlapping part to the first sensing occasion is less than or equal to a third proportion, or a proportion of the non-overlapping part to the first sensing occasion is greater than or equal to a fourth proportion;
an available resource set corresponding to the second sensing occasion and an available resource set corresponding to the first sensing occasion are at least partially overlapped;
a quantity of resources in an overlapping part of the available resource set corresponding to the second sensing occasion and the available resource set corresponding to the first sensing occasion is less than or equal to a fifth threshold, or the quantity of resources in the overlapping part is greater than or equal to a sixth threshold, or a proportion of the quantity of resources in the overlapping part to the available resource set corresponding to the second sensing occasion or the available resource set corresponding to the first sensing occasion is less than or equal to a fifth proportion, or a proportion of the overlapping part to the available resource set corresponding to the second sensing occasion or the available resource set corresponding to the first sensing occasion is greater than or equal to a sixth proportion;
the second sensing occasion and/or the triggered sensing occasion meet a preset condition for triggering sensing;
a condition for determining a PBPS occasion and/or triggering PBPS;
a condition for determining a CPS occasion and/or triggering CPS;
a quantity of triggered sensing occasions is greater than or equal to a first value;
a sum of a quantity of second sensing occasions and the quantity of triggered sensing occasions is greater than or equal to a second value;
the quantity of second sensing occasions is greater than or equal to a third value;
a quantity of preset occasions is greater than or equal to a fourth value;
a quantity of sensing occasions determined by the terminal is greater than or equal to a fifth value;
a quantity of preset occasions in available resource set determined by the terminal is greater than or equal to a sixth value;
at least part of a first reservation period value is less than a seventh value;
at least part of a second reservation period value used to determine the PBPS occasion is less than an eighth value;
a non-overlapping part between the PBPS occasion and the CPS occasion is greater than or equal to a ninth value, or a proportion of the non-overlapping part to the PBPS occasion is greater than or equal to a ninth proportion;
a non-overlapping part between the PBPS occasion and the second sensing occasion is greater than or equal to a tenth value, or a proportion of the non-overlapping part to the PBPS occasion is greater than or equal to a tenth proportion;
a quantity of overlapping parts between the PBPS occasion and the CPS occasion is less than or equal to an eleventh value, or a proportion of the overlapping parts to the PBPS occasion is less than or equal to an eleventh proportion;
a quantity of overlapping parts between the PBPS occasion and the second sensing occasion is less than or equal to a twelfth value, or a proportion of the overlapping parts to the PBPS occasion is less than or equal to a twelfth value;
at least part of occasions in PBPS occasions are not overlapped, or an overlapping part of the at least part of occasions is less than a thirteenth value, or a proportion of the overlapping part between the at least part of occasions to the PBPS occasions is less than a thirteenth proportion;
at least part of a third reservation period value is greater than or equal to an eighteenth value;

at least part of a fourth reservation period value used to determine the PBPS occasion is greater than or equal to a nineteenth value;
a non-overlapping part between the CPS occasion and the PBPS occasion is greater than or equal to a twentieth value, or a proportion of the non-overlapping part to the CPS occasion is greater than or equal to a twentieth proportion;
a non-overlapping part between the CPS occasion and the second sensing occasion is greater than or equal to a twenty-first value, or a proportion of the non-overlapping part to the CPS occasion is greater than or equal to a twenty-first proportion;
a quantity of overlapping parts between the CPS occasion and the PBPS occasion is less than or equal to a twenty-second value, or a proportion of the overlapping parts to the CPS occasion is less than or equal to a twenty-second proportion;
a quantity of overlapping parts between the CPS occasion and the second sensing occasion is less than or equal to a twenty-third value, or a proportion of the overlapping parts to the CPS occasion is less than or equal to a twenty-third proportion;
at least part of occasions in CPS occasions are not overlapped, or an overlapping part between the at least part of occasions is greater than or equal to a twenty-fourth value, or a proportion of an overlapping part between the at least part of occasions to the CPS occasions is greater than or equal to a twenty-fourth proportion;
a quantity of preset occasions in the available resource set is less than or equal to i×P—the processing time, where i is a positive integer, and P is a fifth reservation period value, or P is a sixth reservation period value used to determine the PBPS occasion;
there is no sensing occasion in a preset time period, or the sensing occasion is less than a preset value, or the sensing occasion does not correspond to the first procedure;
the second sensing occasion and/or the triggered sensing occasion meet a preset condition for not triggering sensing;
at least part of sensing occasions are continuous, and a quantity of sensing occasions or a quantity of continuous sensing occasions exceeds a seventh threshold; and
a condition determined by the terminal.

In a possible implementation, in a case that a second preset condition is met, the target sensing occasion does not include the second sensing occasion; and the second preset condition includes one or more of the following:
one or more conditions in the first preset condition are not met;
at least part of reserved resources corresponding to the second sensing occasion are excluded;
the second sensing occasion is a non-monitor occasion;
the second sensing occasion at least partially overlaps with an occasion used by the terminal to perform SL sending;
the second sensing occasion at least partially overlaps with an occasion used by the terminal to perform non-SL sending or receiving;
the second sensing occasion does not overlap with a sensing occasion corresponding to the first procedure;
an overlapping part between the second sensing occasion and the first sensing occasion is less than or equal to an eighth threshold, or the overlapping part is greater than or equal to a ninth threshold, or a proportion of the overlapping part to the first sensing occasion is less than or equal to a seventh proportion, or a proportion of the overlapping part to the first sensing occasion is greater than or equal to an eighth proportion;
the second sensing occasion and/or the triggered sensing occasion do not meet a preset condition for triggering sensing;
the second sensing occasion and/or the triggered sensing occasion meet a preset condition for not triggering sensing;
a condition for determining the PBPS occasion and/or triggering PBPS is not met;
a condition for determining the CPS occasion and/or triggering CPS is not met;

at least part of sensing occasions are continuous, and a quantity of sensing occasions or a quantity of continuous sensing occasions exceeds a tenth threshold; and
a quantity of preset occasions in the available resource set is less than or equal to j×p—the processing time, where j is a positive integer, and P is a ninth reservation period value, or P is a tenth reservation period value used to determine the PBPS occasion.

In some implementations, the apparatus further includes:
a third determining module, used by the terminal to determine the first sensing occasion and/or an available resource set.

In a possible implementation, the second determining module is further configured to:
perform, by the terminal, exclusion for periodic reservation and exclusion for aperiodic reservation based on the target sensing occasion.

In a possible implementation, the target sensing occasion includes a first set and/or a second set;

the first set is at least part of a CPS occasion corresponding to the first procedure and/or at least part of a CPS occasion corresponding to the second procedure; and

the second set is at least part of a PBPS occasion corresponding to the first procedure and/or at least part of a PBPS occasion corresponding to the second procedure.

In a possible implementation, the second determining module is further configured to perform at least one of the following:
performing, by the terminal, exclusion for aperiodic reservation based on a sensing occasion in the first set; and
performing, by the terminal, exclusion for periodic reservation based on a sensing occasion in the second set, or performing, by the terminal, exclusion for periodic reservation and exclusion for aperiodic reservation based on a sensing occasion in the second set.

In some implementations, the apparatus further includes:
an excluding module, configured to perform, by the terminal, periodic exclusion and/or aperiodic exclusion based on a non-monitor occasion.

In this embodiment of this application, the terminal determines a proper target sensing occasion, where the target sensing occasion includes a sensing occasion corresponding to a first procedure, and/or a second sensing occasion that does not overlap with at least part of the first sensing occasion and that is at least partially corresponding to the second procedure, to obtain more sensing results, and improve reliability of resource determination.

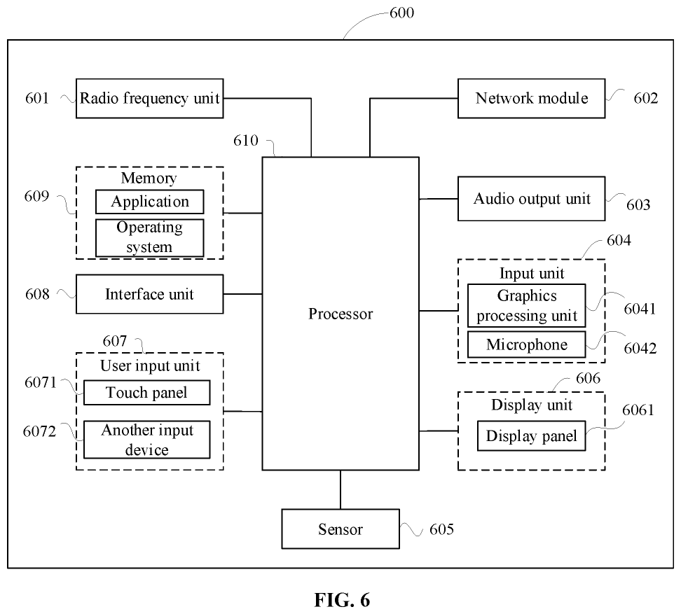

FIG. 6 is a schematic diagram of a hardware structure of a terminal according to an embodiment of this application.

A terminal 600 includes but is not limited to components such as a radio frequency unit 601, a network module 602, an audio output unit 603, an input unit 604, a sensor 605, a display unit 606, a user input unit 607, an interface unit 608, a memory 609, and a processor 610.

A person skilled in the art can understand that the terminal 600 may further include a power supply (such as a battery) that supplies power to each component. The power supply may be logically connected to the processor 610 by using a power supply management system, to implement functions such as charging and discharging management, and power consumption management by using the power supply management system. The terminal structure shown in FIG. 6 constitutes no limitation on the terminal, and the terminal may include more or fewer components than those shown in the figure, or combine some components, or have different component arrangements. Details are not described herein.

It should be understood that, in this embodiment of this application, the input unit 604 may include a graphics processing unit (GPU) 6041 and a microphone 6042, and the graphics processing unit 6041 processes image data of a still picture or video obtained by an image capture apparatus (such as a camera) in a video capture mode or an image capture mode. The display unit 606 may include a display panel 6061. Optionally, the display panel 6061 maybe configured in a form such as a liquid crystal display or an organic light-emitting diode. The user input unit 607 includes a touch panel 6061 and another input device 6072. The touch panel 6061 is also referred to as a touchscreen. The touch panel 6061 may include two parts: a touch detection apparatus and a touch controller. The another input device 6072 may include but is not limited to a physical keyboard, a functional button (such as a volume control button or a power on/off button), a trackball, a mouse, and a joystick. Details are not described herein.

In this embodiment of this application, the radio frequency unit 601 receives downlink data from a network side device and then sends the downlink data to the processor 610 for processing; and sends uplink data to the network side device. Usually, the radio frequency unit 601 includes but is not limited to an antenna, at least one amplifier, a transceiver, a coupler, a low noise amplifier, a duplexer, and the like.

The memory 609 may be configured to store a software program or an instruction and various data. The memory 609 may mainly include a program or instruction storage area and a data storage area. The program or instruction storage area may store an operating system, an application or an instruction required by at least one function (for example, a sound playing function or an image playing function), and the like. In addition, the memory 609 may include a high-speed random access memory, and may further include a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory, for example, at least one disk storage device, a flash memory device, or another non-volatile solid-state storage device.

The processor 610 may include one or more processing units. Optionally, an application processor and a modem processor may be integrated into the processor 610. The application processor mainly processes an operating system, a user interface, an application, an instruction, or the like. The modem processor mainly processes wireless communication, for example, a baseband processor. It may be understood that, alternatively, the modem processor may not be integrated into the processor 610.

The processor 610 is used by a terminal to determine a target sensing occasion for a first procedure.

The processor 610 is used by the terminal to determine a target resource based on the target sensing occasion.

The target sensing occasion includes a first sensing occasion, or the target sensing occasion includes a first sensing occasion and a second sensing occasion, where the first sensing occasion is a sensing occasion corresponding to the first procedure, the second sensing occasion does not overlap with at least part of the first sensing occasion, at least part of the second sensing occasion corresponds to a second procedure, and the second procedure is a procedure different from the first procedure.

In a possible implementation, the target sensing occasion includes one or more of the following:
a preset occasion within a preset time range, where the preset time range is any one of preset time, a preset time window, or a preset timer, and the preset occasion is any one of an occasion, a sensing occasion, an SL occasion, an SL occasion that is not used for transmission of a synchronization signal, an occasion other than a non-monitor occasion, or an SL occasion in a resource pool;
a sensing occasion corresponding to the first procedure;
a sensing occasion corresponding to the second procedure;
a triggered sensing occasion corresponding to the first procedure; and
a sensing occasion determined by the terminal.

In a possible implementation, the sensing occasion includes one or more of the following:
a PBPS occasion; and
a CPS occasion

In a possible implementation, the preset time range meets one or more of the following:
duration of the preset time range is 31 slots, 32 slots, 1 second, 100 slots, 1000 slots, a minimum value CPSmin of a quantity of CPS occasions, a quantity Y of resources in an available resource set corresponding to the first procedure, a minimum value Ymin of the quantity of resources in the available resource set, duration greater than or equal to CPSmin, duration greater than or equal to Y, or duration greater than or equal to Ymin;
duration, a start point, and/or an end point of the preset time range are determined based on a preset period value;
the start point of the preset time range is a moment n, the start point of the preset time range is a moment obtained by the moment n plus a first preset offset, or the start point of the preset time range is a moment obtained by the moment n minus a second preset offset, where the moment n is a triggering moment of the first procedure;
the end point of the preset time range is a moment m, the end point of the preset time range is a moment obtained by the moment m plus a third preset offset, or the end point of the preset time range is a moment obtained by the moment m minus a fourth preset offset, where the moment m is a moment in the available resource set corresponding to the first procedure;
the start point of the preset time range is a moment of a start point determined based on the preset period value plus a fifth preset offset, or the start point of the preset time range is a moment of the start point determined based on the preset period value minus a sixth preset offset;
the end point of the preset time range is a moment of an end point determined based on the preset period value plus a seventh preset offset, or the end point of the preset time range is a moment of the end point determined based on the preset period value minus an eighth preset offset;
the start point of the preset time range is a moment n′, the start point of the preset time range is a moment obtained by the moment n′ plus a ninth preset offset, or the start point of the preset time range is a moment obtained by the moment n′ minus a tenth preset offset, where the moment n′ is a triggering moment of a resource selection or reselection procedure corresponding to the first procedure, or the moment n′ is a moment in the available resource set corresponding to the first procedure, or the moment n′ is a reporting moment of the available resource set or a target resource corresponding to the first procedure;
the start point and the end point of the preset time range are spaced apart by an eleventh preset offset; and
the end point of the preset time range is an end moment of a packet delay budget PDB, the end point of the preset time range is a moment of the end moment of the PDB minus a preset offset, or the end point of the preset time range is a moment of the end moment of the PDB plus the preset offset.

In a possible implementation, in a case that a first preset condition is met, the target sensing occasion includes the second sensing occasion; and

the first preset condition includes one or more of the following:
the second sensing occasion is within a preset time range, where the preset time range is any one of preset time, a preset time window, or a preset timer;
a gap between the second sensing occasion and a moment n is greater than or equal to processing time, where the moment n is a triggering moment of the first procedure, and the processing time is greater than or equal to time required for decoding sidelink control information SCI and/or time required for reporting a target resource;
the gap between the second sensing occasion and the moment n is greater than or equal to the processing time;
the second sensing occasion is located in a K^{th} PBPS occasion, where K is a preset value;
an overlapping part between the second sensing occasion and the first sensing occasion is less than or equal to a first threshold, or the overlapping part is greater than or equal to a second threshold, or a proportion of the overlapping part to the first sensing occasion is less than or equal to a first proportion, or a proportion of the overlapping part to the first sensing occasion is greater than or equal to a second proportion;
a part that is in the first sensing occasion and that does not overlap with the second sensing occasion is less than or equal to a third threshold, or the non-overlapping part is greater than or equal to a fourth threshold, or a proportion of the non-overlapping part to the first sensing occasion is less than or equal to a third proportion, or a proportion of the non-overlapping part to the first sensing occasion is greater than or equal to a fourth proportion;
an available resource set corresponding to the second sensing occasion and an available resource set corresponding to the first sensing occasion are at least partially overlapped;
a quantity of resources in an overlapping part of the available resource set corresponding to the second sensing occasion and the available resource set corresponding to the first sensing occasion is less than or equal to a fifth threshold, or the quantity of resources in the overlapping part is greater than or equal to a sixth threshold, or a proportion of the quantity of resources in the overlapping part to the available resource set corresponding to the second sensing occasion or the available resource set corresponding to the first sensing occasion is less than or equal to a fifth proportion, or a proportion of the overlapping part to the available resource set corresponding to the second sensing occasion or the available resource set corresponding to the first sensing occasion is greater than or equal to a sixth proportion;
the second sensing occasion and/or the triggered sensing occasion meet a preset condition for triggering sensing;
a condition for determining a PBPS occasion and/or triggering PBPS;
a condition for determining a CPS occasion and/or triggering CPS;
a quantity of triggered sensing occasions is greater than or equal to a first value;
a sum of a quantity of second sensing occasions and the quantity of triggered sensing occasions is greater than or equal to a second value;
the quantity of second sensing occasions is greater than or equal to a third value;
a quantity of preset occasions is greater than or equal to a fourth value;
a quantity of sensing occasions determined by the terminal is greater than or equal to a fifth value;
a quantity of preset occasions in available resource set determined by the terminal is greater than or equal to a sixth value;
at least part of a first reservation period value is less than a seventh value;
at least part of a second reservation period value used to determine the PBPS occasion is less than an eighth value;
a non-overlapping part between the PBPS occasion and the CPS occasion is greater than or equal to a ninth value, or a proportion of the non-overlapping part to the PBPS occasion is greater than or equal to a ninth proportion;
a non-overlapping part between the PBPS occasion and the second sensing occasion is greater than or equal to a tenth value, or a proportion of the non-overlapping part to the PBPS occasion is greater than or equal to a tenth proportion;
a quantity of overlapping parts between the PBPS occasion and the CPS occasion is less than or equal to an eleventh value, or a proportion of the overlapping parts to the PBPS occasion is less than or equal to an eleventh proportion;
a quantity of overlapping parts between the PBPS occasion and the second sensing occasion is less than or equal to a twelfth value, or a proportion of the overlapping parts to the PBPS occasion is less than or equal to a twelfth value;
at least part of occasions in PBPS occasions are not overlapped, or an overlapping part of the at least part of occasions is less than a thirteenth value, or a proportion of the overlapping part between the at least part of occasions to the PBPS occasions is less than a thirteenth proportion;
at least part of a third reservation period value is greater than or equal to an eighteenth value;
at least part of a fourth reservation period value used to determine the PBPS occasion is greater than or equal to a nineteenth value;
a non-overlapping part between the CPS occasion and the PBPS occasion is greater than or equal to a twentieth value, or a proportion of the non-overlapping part to the CPS occasion is greater than or equal to a twentieth proportion;
a non-overlapping part between the CPS occasion and the second sensing occasion is greater than or equal to a twenty-first value, or a proportion of the non-overlapping part to the CPS occasion is greater than or equal to a twenty-first proportion;
a quantity of overlapping parts between the CPS occasion and the PBPS occasion is less than or equal to a twenty-second value, or a proportion of the overlapping parts to the CPS occasion is less than or equal to a twenty-second proportion;
a quantity of overlapping parts between the CPS occasion and the second sensing occasion is less than or equal to a twenty-third value, or a proportion of the overlapping parts to the CPS occasion is less than or equal to a twenty-third proportion;
at least part of occasions in CPS occasions are not overlapped, or an overlapping part between the at least part of occasions is greater than or equal to a twenty-fourth value, or a proportion of an overlapping part between the at least part of occasions to the CPS occasions is greater than or equal to a twenty-fourth proportion;
a quantity of preset occasions in the available resource set is less than or equal to i×P—the processing time, where i is a positive integer, and P is a fifth reservation period value, or P is a sixth reservation period value used to determine the PBPS occasion;
there is no sensing occasion in a preset time period, or the sensing occasion is less than a preset value, or the sensing occasion does not correspond to the first procedure;
the second sensing occasion and/or the triggered sensing occasion meet a preset condition for not triggering sensing;
at least part of sensing occasions are continuous, and a quantity of sensing occasions or a quantity of continuous sensing occasions exceeds a seventh threshold; and
a condition determined by the terminal.

In a possible implementation, in a case that a second preset condition is met, the target sensing occasion does not include the second sensing occasion; and

the second preset condition includes one or more of the following:
one or more conditions in the first preset condition are not met;
at least part of reserved resources corresponding to the second sensing occasion are excluded;
the second sensing occasion is a non-monitor occasion;
the second sensing occasion at least partially overlaps with an occasion used by the terminal to perform SL sending;
the second sensing occasion at least partially overlaps with an occasion used by the terminal to perform non-SL sending or receiving;
the second sensing occasion does not overlap with a sensing occasion corresponding to the first procedure;
an overlapping part between the second sensing occasion and the first sensing occasion is less than or equal to an eighth threshold, or the overlapping part is greater than or equal to a ninth threshold, or a proportion of the overlapping part to the first sensing occasion is less than or equal to a seventh proportion, or a proportion of the overlapping part to the first sensing occasion is greater than or equal to an eighth proportion;
the second sensing occasion and/or the triggered sensing occasion do not meet a preset condition for triggering sensing;
the second sensing occasion and/or the triggered sensing occasion meet a preset condition for not triggering sensing;
a condition for determining the PBPS occasion and/or triggering PBPS is not met;
a condition for determining the CPS occasion and/or triggering CPS is not met;
at least part of sensing occasions are continuous, and a quantity of sensing occasions or a quantity of continuous sensing occasions exceeds a tenth threshold; and
a quantity of preset occasions in the available resource set is less than or equal to j×p—the processing time, where j is a positive integer, and P is a ninth reservation period value, or P is a tenth reservation period value used to determine the PBPS occasion.

In a possible implementation, the processor 610 is used by the terminal to determine the first sensing occasion and/or an available resource set.

In a possible implementation, the processor 610 is further configured to:
perform, by the terminal, exclusion for periodic reservation and exclusion for aperiodic reservation based on the target sensing occasion.

In a possible implementation, the target sensing occasion includes a first set and/or a second set;

the first set is at least part of a CPS occasion corresponding to the first procedure and/or at least part of a CPS occasion corresponding to the second procedure; and

the second set is at least part of a PBPS occasion corresponding to the first procedure and/or at least part of a PBPS occasion corresponding to the second procedure.

In a possible implementation, the processor 610 is further configured to perform at least one of the following:
performing, by the terminal, exclusion for aperiodic reservation based on a sensing occasion in the first set; and
performing, by the terminal, exclusion for periodic reservation based on a sensing occasion in the second set, or performing, by the terminal, exclusion for periodic reservation and exclusion for aperiodic reservation based on a sensing occasion in the second set.

In a possible implementation, the processor 610 is configured to perform, by the terminal, periodic exclusion and/or aperiodic exclusion based on a non-monitor occasion.

In this embodiment of this application, the terminal determines a proper target sensing occasion, where the target sensing occasion includes a sensing occasion corresponding to a first procedure, and/or a second sensing occasion that does not overlap with at least part of the first sensing occasion and that is at least partially corresponding to the second procedure, to obtain more sensing results, and improve reliability of resource determination.

An embodiment of this application further provides a computer program product. The computer program product is stored in a non-volatile storage medium, and the computer program product is executed by at least one processor to implement the steps of the processing method described in FIG. 2.

An embodiment of this application further provides a readable storage medium. The readable storage medium stores a program or an instruction, and when the program or the instruction is executed by a processor, the processes of the foregoing method embodiments shown in FIG. 2 are implemented, and a same technical effect achieved can be achieved. To avoid repetition, details are not described herein again.

The processor is a processor in the terminal in the foregoing embodiment. The readable storage medium includes a computer-readable storage medium, such as a computer read-only memory (ROM), a random access memory (RAM), a magnetic disk, or an optical disc.

An embodiment of this application further provides a chip. The chip includes a processor and a communication interface, the communication interface is coupled to the processor, and the processor is configured to run a program or an instruction of a network side device to implement the processes of the method embodiment shown in FIG. 2, and a same technical effect can be achieved. To avoid repetition, details are not described herein again.

It should be understood that the chip mentioned in this embodiment of this application may also be referred to as a system-level chip, a system chip, a chip system, or a system on chip.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. An element limited by “includes a . . . ” does not, without more constraints, preclude the presence of additional identical elements in the process, method, article, or apparatus that includes the element. In addition, it should be noted that the scope of the method and the apparatus in the implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a software product. The computer software product is stored in a storage medium (such as a ROM/RAM, a hard disk, or an optical disc), and includes several instructions for instructing a terminal (which may be mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A resource determining method, comprising:
determining, by a terminal, a target sensing occasion for a first procedure; and
determining, by the terminal, a target resource based on the target sensing occasion; wherein
the target sensing occasion comprises a first sensing occasion, wherein the first sensing occasion is a sensing occasion corresponding to the first procedure.

2. The method according to claim 1, wherein the target sensing occasion comprises one or more of the following:
a sensing occasion within a preset time range, wherein a start point of the preset time range is a moment obtained by the moment n minus an offset, wherein the moment n is a triggering moment of the first procedure;
a sensing occasion corresponding to a second procedure;
a triggered sensing occasion corresponding to the first procedure; or
a sensing occasion determined by the terminal.

3. The method according to claim 1, wherein the first procedure comprises a resource selection procedure, a re-evaluation, and/or a pre-emption evaluation.

4. The method according to claim 1, wherein the sensing occasion comprises one or more of the following:
a periodic based partial sensing (PBPS) occasion; or
a continuous partial sensing (CPS) occasion.

5. The method according to claim 1, wherein in a case that a first preset condition is met, the target sensing occasion further comprises a second sensing occasion, wherein the second sensing occasion does not overlap with at least part of the first sensing occasion, at least part of the second sensing occasion corresponds to a second procedure, and the second procedure is a procedure different from the first procedure; and
the first preset condition comprises one or more of the following:
the second sensing occasion is within a preset time range;
a gap between the second sensing occasion and a moment n is greater than or equal to processing time, wherein the moment n is a triggering moment of the first procedure, and the processing time is greater than or equal to time required for decoding sidelink control information (SCI) and/or time required for reporting a target resource;
the gap between the second sensing occasion and the moment n is greater than or equal to the processing time;
the second sensing occasion is located in a K^{th} PBPS occasion, wherein K is a preset value;
an overlapping part between the second sensing occasion and the first sensing occasion is less than or equal to a first threshold, or the overlapping part is greater than or equal to a second threshold, or a proportion of the overlapping part to the first sensing occasion is less than or equal to a first proportion, or a proportion of the overlapping part to the first sensing occasion is greater than or equal to a second proportion;
a part that is in the first sensing occasion and that does not overlap with the second sensing occasion is less than or equal to a third threshold, or the non-overlapping part is greater than or equal to a fourth threshold, or a proportion of the non-overlapping part to the first sensing occasion is less than or equal to a third proportion, or a proportion of the non-overlapping part to the first sensing occasion is greater than or equal to a fourth proportion;
an available resource set corresponding to the second sensing occasion and an available resource set corresponding to the first sensing occasion are at least partially overlapped;
a quantity of resources in an overlapping part of the available resource set corresponding to the second sensing occasion and the available resource set corresponding to the first sensing occasion is less than or equal to a fifth threshold, or the quantity of resources in the overlapping part is greater than or equal to a sixth threshold, or a proportion of the quantity of resources in the overlapping part to the available resource set corresponding to the second sensing occasion or the available resource set corresponding to the first sensing occasion is less than or equal to a fifth proportion, or a proportion of the overlapping part to the available resource set corresponding to the second sensing occasion or the available resource set corresponding to the first sensing occasion is greater than or equal to a sixth proportion;
the second sensing occasion and/or the triggered sensing occasion meet a preset condition for triggering sensing;
a condition for determining a PBPS occasion and/or triggering PBPS;
a condition for determining a CPS occasion and/or triggering CPS;
a quantity of triggered sensing occasions is greater than or equal to a first value;
a sum of a quantity of second sensing occasions and the quantity of triggered sensing occasions is greater than or equal to a second value;
the quantity of second sensing occasions is greater than or equal to a third value;
a quantity of preset occasions is greater than or equal to a fourth value;
a quantity of sensing occasions determined by the terminal is greater than or equal to a fifth value;
a quantity of preset occasions in available resource set determined by the terminal is greater than or equal to a sixth value;
at least part of a first reservation period value is less than a seventh value;
at least part of a second reservation period value used to determine the PBPS occasion is less than an eighth value;
a non-overlapping part between the PBPS occasion and the CPS occasion is greater than or equal to a ninth value, or a proportion of the non-overlapping part to the PBPS occasion is greater than or equal to a ninth proportion;
a non-overlapping part between the PBPS occasion and the second sensing occasion is greater than or equal to a tenth value, or a proportion of the non-overlapping part to the PBPS occasion is greater than or equal to a tenth proportion;
a quantity of overlapping part between the PBPS occasion and the CPS occasion is less than or equal to an eleventh value, or a proportion of the overlapping part to the PBPS occasion is less than or equal to an eleventh proportion;
a quantity of overlapping parts between the PBPS occasion and the second sensing occasion is less than or equal to a twelfth value, or a proportion of the overlapping parts to the PBPS occasion is less than or equal to a twelfth value;
at least part of occasions in PBPS occasions are not overlapped, or an overlapping part of the at least part of occasions is less than a thirteenth value, or a proportion of the overlapping part between the at least part of occasions to the PBPS occasions is less than a thirteenth proportion;
at least part of a third reservation period value is greater than or equal to an eighteenth value;
at least part of a fourth reservation period value used to determine the PBPS occasion is greater than or equal to a nineteenth value;
a non-overlapping part between the CPS occasion and the PBPS occasion is greater than or equal to a twentieth value, or a proportion of the non-overlapping part to the CPS occasion is greater than or equal to a twentieth proportion;
a non-overlapping part between the CPS occasion and the second sensing occasion is greater than or equal to a twenty-first value, or a proportion of the non-overlapping part to the CPS occasion is greater than or equal to a twenty-first proportion;
a quantity of overlapping parts between the CPS occasion and the PBPS occasion is less than or equal to a twenty-second value, or a proportion of the overlapping parts to the CPS occasion is less than or equal to a twenty-second proportion;
a quantity of overlapping parts between the CPS occasion and the second sensing occasion is less than or equal to a twenty-third value, or a proportion of the overlapping parts to the CPS occasion is less than or equal to a twenty-third proportion;
at least part of occasions in CPS occasions are not overlapped, or an overlapping part between the at least part of occasions is greater than or equal to a twenty-fourth value, or a proportion of an overlapping part between the at least part of occasions to the CPS occasions is greater than or equal to a twenty-fourth proportion;
a quantity of preset occasions in the available resource set is less than or equal to i×P—the processing time, wherein i is a positive integer, and P is a fifth reservation period value, or P is a sixth reservation period value used to determine the PBPS occasion;
there is no sensing occasion in a preset time period, or the sensing occasion is less than a preset value, or the sensing occasion does not correspond to the first procedure;
the second sensing occasion and/or the triggered sensing occasion meet a preset condition for not triggering sensing;
at least part of sensing occasions are continuous, and a quantity of sensing occasions or a quantity of continuous sensing occasions exceeds a seventh threshold; or
a condition determined by the terminal.

6. The method according to claim 5, wherein in a case that a second preset condition is met, the target sensing occasion does not comprise the second sensing occasion; and
the second preset condition comprises one or more of the following:
one or more conditions in the first preset condition are not met;
at least part of reserved resources corresponding to the second sensing occasion are excluded;
the second sensing occasion is a non-monitor occasion;
the second sensing occasion at least partially overlaps with an occasion used by the terminal to perform SL sending;
the second sensing occasion at least partially overlaps with an occasion used by the terminal to perform non-SL sending or receiving;
the second sensing occasion does not overlap with a sensing occasion corresponding to the first procedure;
an overlapping part between the second sensing occasion and the first sensing occasion is less than or equal to an eighth threshold, or the overlapping part is greater than or equal to a ninth threshold, or a proportion of the overlapping part to the first sensing occasion is less than or equal to a seventh proportion, or a proportion of the overlapping part to the first sensing occasion is greater than or equal to an eighth proportion;
the second sensing occasion and/or the triggered sensing occasion do not meet a preset condition for triggering sensing;
the second sensing occasion and/or the triggered sensing occasion meet a preset condition for not triggering sensing;
a condition for determining the PBPS occasion and/or triggering PBPS is not met;
a condition for determining the CPS occasion and/or triggering CPS is not met;
at least part of sensing occasions are continuous, and a quantity of sensing occasions or a quantity of continuous sensing occasions exceeds a tenth threshold; or
a quantity of preset occasions in the available resource set is less than or equal to j×p—the processing time, wherein j is a positive integer, and P is a ninth reservation period value, or P is a tenth reservation period value used to determine the PBPS occasion.

7. The method according to claim 1, wherein the method further comprises:
determining, by the terminal, the first sensing occasion and/or an available resource set.

8. The method according to claim 1, wherein the determining, by the terminal, a target resource based on the target sensing occasion comprises:
performing, by the terminal, exclusion for periodic reservation and exclusion for aperiodic reservation based on the target sensing occasion.

9. The method according to claim 1, wherein the target sensing occasion comprises a first set and/or a second set;
the first set is at least part of a CPS occasion corresponding to the first procedure and/or at least part of a CPS occasion corresponding to the second procedure; and
the second set is at least part of a PBPS occasion corresponding to the first procedure and/or at least part of a PBPS occasion corresponding to the second procedure.

10. The method according to claim 9, wherein the determining, by the terminal, a target resource based on the target sensing occasion comprises one or more of the following:
performing, by the terminal, exclusion for aperiodic reservation based on a sensing occasion in the first set; or
performing, by the terminal, exclusion for periodic reservation based on a sensing occasion in the second set, or performing, by the terminal, exclusion for periodic reservation and exclusion for aperiodic reservation based on a sensing occasion in the second set.

11. The method according to claim 1, wherein the method further comprises:
performing, by the terminal, periodic exclusion and/or aperiodic exclusion based on a non-monitor occasion.

12. A terminal, comprising a processor, a memory, and a program that is stored in the memory and that can be run on the processor, wherein the program, when executed by the processor, causes the terminal to perform:
determining a target sensing occasion for a first procedure; and
determining a target resource based on the target sensing occasion; wherein
the target sensing occasion comprises a first sensing occasion, wherein the first sensing occasion is a sensing occasion corresponding to the first procedure.

13. The terminal according to claim 12, wherein the target sensing occasion comprises one or more of the following:
a sensing occasion within a preset time range, wherein a start point of the preset time range is a moment obtained by the moment n minus an offset, wherein the moment n is a triggering moment of the first procedure;
a sensing occasion corresponding to a second procedure;
a triggered sensing occasion corresponding to the first procedure; or
a sensing occasion determined by the terminal.

14. The terminal according to claim 12, wherein the first procedure comprises a resource selection procedure, a re-evaluation, and/or a pre-emption evaluation.

15. The terminal according to claim 12, wherein the sensing occasion comprises one or more of the following:
a periodic based partial sensing (PBPS) occasion; or
a continuous partial sensing (CPS) occasion.

16. The terminal according to claim 12, wherein in a case that a first preset condition is met, the target sensing occasion further comprises a second sensing occasion, wherein the second sensing occasion does not overlap with at least part of the first sensing occasion, at least part of the second sensing occasion corresponds to a second procedure, and the second procedure is a procedure different from the first procedure; and
the first preset condition comprises one or more of the following:
the second sensing occasion is within a preset time range;
a gap between the second sensing occasion and a moment n is greater than or equal to processing time, wherein the moment n is a triggering moment of the first procedure, and the processing time is greater than or equal to time required for decoding sidelink control information (SCI) and/or time required for reporting a target resource;
the gap between the second sensing occasion and the moment n is greater than or equal to the processing time;
the second sensing occasion is located in a Kth PBPS occasion, wherein K is a preset value;
an overlapping part between the second sensing occasion and the first sensing occasion is less than or equal to a first threshold, or the overlapping part is greater than or equal to a second threshold, or a proportion of the overlapping part to the first sensing occasion is less than or equal to a first proportion, or a proportion of the overlapping part to the first sensing occasion is greater than or equal to a second proportion;
a part that is in the first sensing occasion and that does not overlap with the second sensing occasion is less than or equal to a third threshold, or the non-overlapping part is greater than or equal to a fourth threshold, or a proportion of the non-overlapping part to the first sensing occasion is less than or equal to a third proportion, or a proportion of the non-overlapping part to the first sensing occasion is greater than or equal to a fourth proportion;
an available resource set corresponding to the second sensing occasion and an available resource set corresponding to the first sensing occasion are at least partially overlapped;
a quantity of resources in an overlapping part of the available resource set corresponding to the second sensing occasion and the available resource set corresponding to the first sensing occasion is less than or equal to a fifth threshold, or the quantity of resources in the overlapping part is greater than or equal to a sixth threshold, or a proportion of the quantity of resources in the overlapping part to the available resource set corresponding to the second sensing occasion or the available resource set corresponding to the first sensing occasion is less than or equal to a fifth proportion, or a proportion of the overlapping part to the available resource set corresponding to the second sensing occasion or the available resource set corresponding to the first sensing occasion is greater than or equal to a sixth proportion;
the second sensing occasion and/or the triggered sensing occasion meet a preset condition for triggering sensing;
a condition for determining a PBPS occasion and/or triggering PBPS;
a condition for determining a CPS occasion and/or triggering CPS;
a quantity of triggered sensing occasions is greater than or equal to a first value;
a sum of a quantity of second sensing occasions and the quantity of triggered sensing occasions is greater than or equal to a second value;
the quantity of second sensing occasions is greater than or equal to a third value;
a quantity of preset occasions is greater than or equal to a fourth value;
a quantity of sensing occasions determined by the terminal is greater than or equal to a fifth value;
a quantity of preset occasions in available resource set determined by the terminal is greater than or equal to a sixth value;
at least part of a first reservation period value is less than a seventh value;
at least part of a second reservation period value used to determine the PBPS occasion is less than an eighth value;
a non-overlapping part between the PBPS occasion and the CPS occasion is greater than or equal to a ninth value, or a proportion of the non-overlapping part to the PBPS occasion is greater than or equal to a ninth proportion;
a non-overlapping part between the PBPS occasion and the second sensing occasion is greater than or equal to a tenth value, or a proportion of the non-overlapping part to the PBPS occasion is greater than or equal to a tenth proportion;
a quantity of overlapping part between the PBPS occasion and the CPS occasion is less than or equal to an eleventh value, or a proportion of the overlapping part to the PBPS occasion is less than or equal to an eleventh proportion;
a quantity of overlapping parts between the PBPS occasion and the second sensing occasion is less than or equal to a twelfth value, or a proportion of the overlapping parts to the PBPS occasion is less than or equal to a twelfth value;
at least part of occasions in PBPS occasions are not overlapped, or an overlapping part of the at least part of occasions is less than a thirteenth value, or a proportion of the overlapping part between the at least part of occasions to the PBPS occasions is less than a thirteenth proportion;
at least part of a third reservation period value is greater than or equal to an eighteenth value;
at least part of a fourth reservation period value used to determine the PBPS occasion is greater than or equal to a nineteenth value;
a non-overlapping part between the CPS occasion and the PBPS occasion is greater than or equal to a twentieth value, or a proportion of the non-overlapping part to the CPS occasion is greater than or equal to a twentieth proportion;
a non-overlapping part between the CPS occasion and the second sensing occasion is greater than or equal to a twenty-first value, or a proportion of the non-overlapping part to the CPS occasion is greater than or equal to a twenty-first proportion;
a quantity of overlapping parts between the CPS occasion and the PBPS occasion is less than or equal to a twenty-second value, or a proportion of the overlapping parts to the CPS occasion is less than or equal to a twenty-second proportion;
a quantity of overlapping parts between the CPS occasion and the second sensing occasion is less than or equal to a twenty-third value, or a proportion of the overlapping parts to the CPS occasion is less than or equal to a twenty-third proportion;
at least part of occasions in CPS occasions are not overlapped, or an overlapping part between the at least part of occasions is greater than or equal to a twenty-fourth value, or a proportion of an overlapping part between the at least part of occasions to the CPS occasions is greater than or equal to a twenty-fourth proportion;
a quantity of preset occasions in the available resource set is less than or equal to i×P—the processing time, wherein i is a positive integer, and P is a fifth reservation period value, or P is a sixth reservation period value used to determine the PBPS occasion;
there is no sensing occasion in a preset time period, or the sensing occasion is less than a preset value, or the sensing occasion does not correspond to the first procedure;
the second sensing occasion and/or the triggered sensing occasion meet a preset condition for not triggering sensing;
at least part of sensing occasions are continuous, and a quantity of sensing occasions or a quantity of continuous sensing occasions exceeds a seventh threshold; or
a condition determined by the terminal.

17. The terminal according to claim 16, wherein in a case that a second preset condition is met, the target sensing occasion does not comprise the second sensing occasion; and
the second preset condition comprises one or more of the following:
one or more conditions in the first preset condition are not met;
at least part of reserved resources corresponding to the second sensing occasion are excluded;
the second sensing occasion is a non-monitor occasion;
the second sensing occasion at least partially overlaps with an occasion used by the terminal to perform SL sending;
the second sensing occasion at least partially overlaps with an occasion used by the terminal to perform non-SL sending or receiving;
the second sensing occasion does not overlap with a sensing occasion corresponding to the first procedure;
an overlapping part between the second sensing occasion and the first sensing occasion is less than or equal to an eighth threshold, or the overlapping part is greater than or equal to a ninth threshold, or a proportion of the overlapping part to the first sensing occasion is less than or equal to a seventh proportion, or a proportion of the overlapping part to the first sensing occasion is greater than or equal to an eighth proportion;
the second sensing occasion and/or the triggered sensing occasion do not meet a preset condition for triggering sensing;
the second sensing occasion and/or the triggered sensing occasion meet a preset condition for not triggering sensing;
a condition for determining the PBPS occasion and/or triggering PBPS is not met;
a condition for determining the CPS occasion and/or triggering CPS is not met;
at least part of sensing occasions are continuous, and a quantity of sensing occasions or a quantity of continuous sensing occasions exceeds a tenth threshold; or
a quantity of preset occasions in the available resource set is less than or equal to j×p—the processing time, wherein j is a positive integer, and P is a ninth reservation period value, or P is a tenth reservation period value used to determine the PBPS occasion.

18. A non-transitory readable storage medium, wherein the non-transitory readable storage medium stores a program or an instruction, wherein the program or the instruction, when executed by a processor of a terminal, causes the processor of the terminal to perform:
determining a target sensing occasion for a first procedure; and
determining a target resource based on the target sensing occasion; wherein
the target sensing occasion comprises a first sensing occasion, wherein the first sensing occasion is a sensing occasion corresponding to the first procedure.

19. A computer program product, wherein the computer program product is stored in a non-transient storage medium, and the computer program product is executed by at least one processor to implement the steps of the method according to claim 1.

20. A chip, wherein the chip comprises a processor and a communication interface, the communication interface is coupled to the processor, and the processor is configured to run a program or an instruction to implement the steps of the method according to claim 1.
